(19) United States
(12) Patent Application Publication
(10) Pub. No.: US 2024/0403658 A1
(43) Pub. Date: Dec. 5, 2024

(54) MACHINE LEARNING MODEL OPTIMIZATION EXPLAINABILITY

(71) Applicant: C3.ai, Inc., Redwood City, CA (US)

(72) Inventors: Fabian Rigterink, Redwood City, CA (US); Zhaoxi Zhang, Palo Alto, CA (US); Zhaoyang Jin, San Mateo, CA (US); Utsav Dutta, Mountain View, CA (US)

(73) Assignee: C3.ai, Inc., Redwood City, CA (US)

(21) Appl. No.: 18/679,390

(22) Filed: May 30, 2024

Related U.S. Application Data
(60) Provisional application No. 63/505,611, filed on Jun. 1, 2023.

(51) Int. Cl. G06N 20/00

(52) U.S. Cl. CPC G06N 5/01; G06F 40/30; G06N 5/045

(57) ABSTRACT

Machine learning model optimization explainability application is provides explanations (e.g., natural language explanations) for the operations and decisions associated with an optimization model (e.g., optimization algorithm) used to solve an optimization problem. More specifically, the software application for machine learning model optimization explainability enables explainability for a query that determine how the solution was generated. The system can provide a query response (e.g., natural language explanation), and perform a variety of different actions to address any issues surfaced in the query response.

### CROSS-REFERENCE TO RELATED APPLICATIONS

The present application claims the benefit of U.S. Provisional Patent Application Ser. 63/505,611, filed Jun. 1, 2023, and entitled “Optimization Model Explainability,” which is hereby incorporated by reference herein.

### TECHNICAL FIELD

This disclosure pertains to generating and providing explanation information for enterprise artificial intelligence systems using machine learning and generative artificial intelligence.

### BACKGROUND

Many entities (e.g., enterprise systems) use Operations Research (OR) models to improve decision-making processes (e.g., machine learning-based decision-making processes). Generally, Operations Research is an analytical method of computational problem-solving and decision-making and has been used to improve computer simulations, among other technical disciplines. The process of OR can be broadly broken down into (1) identifying a technical problem, (2) constructing a model around the technical problem, (3) using the model to derive technical solutions, (4) testing each technical solution and analyzing success, and (5) implementing the technical solution to address the technical problem.

In other words, OR typically concentrates on defining a technical problem, formulating the model, and solving it. This workflow tends to cover only a one-way translation from the entity specifics (e.g., system specifics, business specifics) to a model (e.g., mathematical model, statistical model, machine learning model). The reverse translation, from the solution of a model back to the entity specifics, is typically not provided and often only includes a presentation of the end-result solution itself.

Since the construction and operations of the OR model are generally opaque, systems and end users are generally limited in their options to interpret solutions themselves or to have solutions get explained to them. As a result, they are forced to accept the fact that the solution is optimal, without being able to interact with or interrogate the solution in any way. This lack of interpretability or explainability creates a lack of trust in the solution, hides unfounded assumptions, and may incorporate unacceptable biases in the solution. Consequently, many OR models are perceived as black or grey boxes. Often these problems are not detected until decisions have been made and implemented. At best, the actions taken based on a poor OR model may be merely suboptimal (e.g., resulting in excessive consumption of computing resources). At worst, utilizing a poor OR model may result in irrevocable damage (e.g., irreversible and/or other damage to one or more computing systems, physical assets, environments, etc.).

### BRIEF DESCRIPTION OF THE DRAWINGS

FIG. 1 depicts a diagram of an example explainability Operations Research (XOR) system according to some implementations.

FIG. 2 depicts a flowchart of an example method of generating an undirected graph based on an optimization algorithm (e.g., OR model) according to some implementations.

FIG. 3 depicts an example dependency graph according to some implementations.

FIG. 4 depicts a flowchart of a method for providing explanation information regarding an optimization algorithm based on the dependency graph according to some implementations.

FIG. 5 depicts an explanation tree according to some implementations.

FIG. 6 depicts the example explanation tree with nodes and paths that may be pruned indicated by a dashed line according to some implementations.

FIG. 7 depicts the example explanation tree with only nodes and paths that cannot be pruned according to some implementations.

FIG. 8 depicts a flowchart of a method for providing explanation information regarding a large pharmaceutical manufacturer optimization algorithm in an example according to some implementations.

FIG. 9 depicts part of a dependency graph for the pharmaceutical manufacturer example including the root node for this example according to some implementations.

FIG. 10 depicts example optimization problems according to some implementations.

FIG. 11 depicts a flowchart of a method for providing explanation information regarding an optimization algorithm based on a dependency graph according to some implementations.

FIG. 12 depicts a flowchart of a method for performing corrective actions based on explanation information regarding a solution to an optimization algorithm according to some implementations.

FIG. 13 depicts a flowchart of a method for using generative artificial intelligence to explain a solution to an optimization problem according to some implementations.

FIG. 14 depicts a diagram of an example system flow for enterprise artificial intelligence OR explainability according to some implementations.

FIG. 15 is a diagram of an example computer system for implementing the features disclosed herein according to some implementations.

### DETAILED DESCRIPTION

Typically, Operations Research (OR) models are perceived as black or grey boxes. The systems and methods described herein allow for OR models, and their associated enterprise artificial intelligence systems, to be perceived as transparent “white boxes” (e.g., by end users or other systems) in which an OR model's internal structure and behavior are available and understood. Implementations of explainable OR (XOR) described herein include a systematic approach to make OR solutions interpretable and explainable to end users and other systems, enabling a two-way translation (e.g., from entity specifics to an abstract mathematical model and back), consequently turning OR models into white boxes to increase trust and adoption by end users and systems.

Opaque solutions that cannot be interpreted or explained can lead to lack of trust and low rates of adoption. By providing explanations (e.g., in a visual format, voice format, interactive active, natural language format, etc.) regarding the OR solutions, this novel software application for machine learning model optimization explainability improves rates of adoption. Further, by providing trust and understandability, there is significant improvement in the speed of iterative model improvement cycles as users and systems are able to provide feedback on model accuracy and more easily.

Based on the explanations, decisions regarding optimization algorithms (e.g., OR models or any optimization models) may be justified, saved, confirmed, inspected, and/or audited. Further, information learned from creating the optimization algorithm, solutions to the optimization algorithm, impact results, and explanations may be used and leveraged to create new optimization algorithms for similar decisions. Example implementations can be applied to optimal or near-optimal solutions to decision-making problems.

In one example, numerous and disparate enterprise systems may control a variety of facilities (e.g., industrial facilities, agricultural facilities) that include many different assets (e.g., machines, containers, etc.). The facilities may be responsible for food or pharmaceutical manufacturing, storage, transportation, etc., and the enterprise systems may control or inform manufacturing processes, supply chain logistics, and the like. Such tasks are particularly problematic when degradation (e.g., spoilage) is involved, as is the case with food and pharmaceutical processes. Accordingly, OR models may be used to provide solutions for such tasks. The systems and methods described herein go several steps further to provide explainability information using machine learning and generative artificial intelligence to ensure optimal or acceptable model performance, and that the solutions are trustworthy, and that actions may be safely and confidently taken based on the solutions.

More specifically, this novel software application for machine learning model optimization explainability enables a solution to be quired that determines how the solution was generated. The system can provide a query response (e.g., visual format explanation, voice format explanation, interactive format explanation, natural language format explanation, etc.), and perform a variety of different actions to address any issues surfaced in the query response. For example, a user may be provided with a solution to an optimization problem that indicates that some materials are wasted. The user may then ask the system “why do I waste material?” and the system can provide an explanation of the processes and decisions that were used to determine the solution. If there are errors in the processes or decisions (e.g., poor data, incorrect logic, etc.) the model can be updated and run again, rather than risk implementing a poor solution. If no errors are detected, then the solution can be safely implemented. For example, if the answer to the query indicates that some assets are underperforming, the system can implement corrective actions (e.g., schedule a maintenance) that addresses the underlying problem.

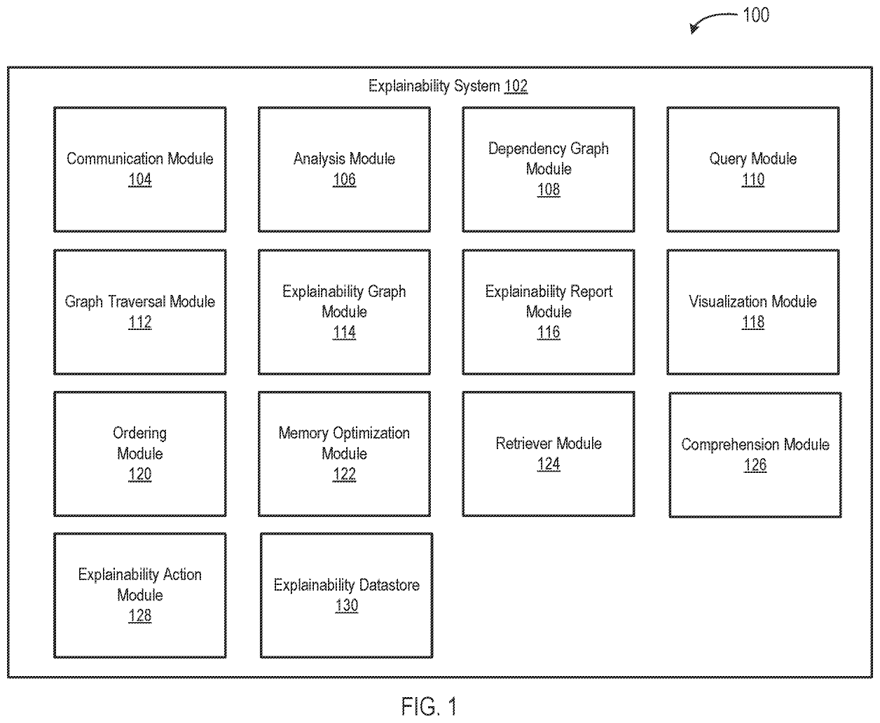

FIG. 1 depicts a diagram 100 of an explainability system 102 according to some implementations. In various implementations, the explainability system 102 is configured to store specifics of a problem formulation of an optimization algorithm (e.g., objectives, variables, constraints, fields, and the like) in a dependency graph structure allowing a problem-agnostic analysis and treatment. Fields can include data fields. By organizing the optimization algorithm in a dependency graph structure, users and systems may query decision variables and aspects of the optimization algorithm that were previously unavailable (e.g., due to the opaqueness of the optimization algorithm and/or a solution of the optimization algorithm). Storing the entity specifics as meta-information in the dependency graph enables automated and interpretable/human-readable explanations (e.g., explanation information) without the need of an end user to have a deep understanding of the underlying model formulation.

In the example of FIG. 1, the explainability system 102 may be configured to receive an optimization algorithm (e.g., OR model or optimization model) regarding any number of entity challenges. The explainability system 102 may allow users and/or systems to provide queries regarding decisions made by or programmed into the optimization algorithm (e.g., based on one or more solutions). Subsequently, after inspecting the optimization algorithm, the explainability system 102 may provide explanations or explanation information regarding the query. An explanation may include information and decisions taken by the optimization algorithm to answer the query. Explanation information may include all or some of the information and decisions taken by the optimization algorithm to answer the query or part of the query. Although queries (e.g., user queries and/or system queries) are discussed herein, it will be appreciated that a query is a type of input, and the systems and methods described herein may use other types of inputs instead of, or in addition to, queries. For example, inputs can include instruction sets, human-readable inputs (e.g., natural language inputs), machine-readable inputs, and/or the like.

In various implementations, the explainability system 102 may provide explanations, explanation information responsive to the query and the optimization algorithm, and/or an explainability graph to one or more systems and/or digital devices (e.g., a device of a user or other entity) by text, email, messaging, on a web page, to an app on a smart device, and/or any other mechanism. In some implementations, the explainability system 102 may be a platform that allows users and/or systems to access the platform and interact with an explainability tree to further inspect the explanation and/or explanation information.

The example explainability system 102 depicted in FIG. 1 includes a communication module 104, an analysis module 106, a dependency graph module 108, a query module 110, a graph traversal module 112, an explainability graph module 114, an explainability report module 116, a visualization module 118, an ordering module 120, a memory optimization module 122, a retriever module 124, a comprehension module 126, an explainability action module 128, and an explainability datastore 130.

The communication module 104 may receive an optimization model. The optimization model may be an OR model and/or any optimization algorithm. In one example, the optimization model may be automatically generated by one or more systems to model a technical problem. In another example, the optimization model may be generated with input from an OR analyst or other person to help model a technical problem. The technical problem may be, for example, a computational simulation problem, an enterprise problem, and/or otherwise. The optimization model may identify real-world constraints, objectives, weights, variables, and the like.

The communication module 104 may receive any number of optimization models from any number of digital devices. For example, the communication module 104 may receive optimization models from any number of other digital devices across a network (e.g., the Internet). In some implementations, one or more systems and/or users may provide the optimization model to the explainability system 102 through an API and/or a platform that is accessible to one or more users and/or systems.

It will be appreciated that the explainability system 102 may receive any number of different optimization models, Operations Analysis models, analyze the models, and provide explainability to any number of users and/or systems. In some implementations, the communication module 104 receives one or more solutions to an optimization model. The optimization model may include or be related to solution data indicating decisions, weights, variables, and/or the like of the optimization model.

The analysis module 106 may analyze the optimization model to identify objectives (e.g., objective terms), constraints, and variables. The counterpart of variables may be fixed parameters. Variables and parameters may or may not participate in an objective or a constraint. In one example, objective term(s) may include a direction (e.g., maximize or minimize). A constraint may be a type (e.g., inequality or equality). A variable may be a type (e.g., continuous, integer, or binary). A domain may be defined by a lower and/or upper bound. The dependency graph module 108 may generate an undirected dependency graph based on the objectives, constraints, and variables. The dependency graphs may represent the objectives, constraints, variables, and parameters as nodes in the dependency graph. If a variable or parameter participates in an objective and/or constraint, the dependency graph module 108 may generate an edge between the two corresponding nodes.

In another example, the dependency graph module 108 may represent objective terms, variables, constraints, and fields (e.g., data fields) as represented as nodes in a directed graph. If a variable participates in an objective term/constraint, then the dependency graph module 108 may generate corresponding bidirectional arcs in the dependency graph representing the relationship(s). If an objective term or a constraint uses a field, the dependency graph module 108 may generate a one-directional arc (objective term/constraint to field). The term field may refer to, and/or include, data fields.

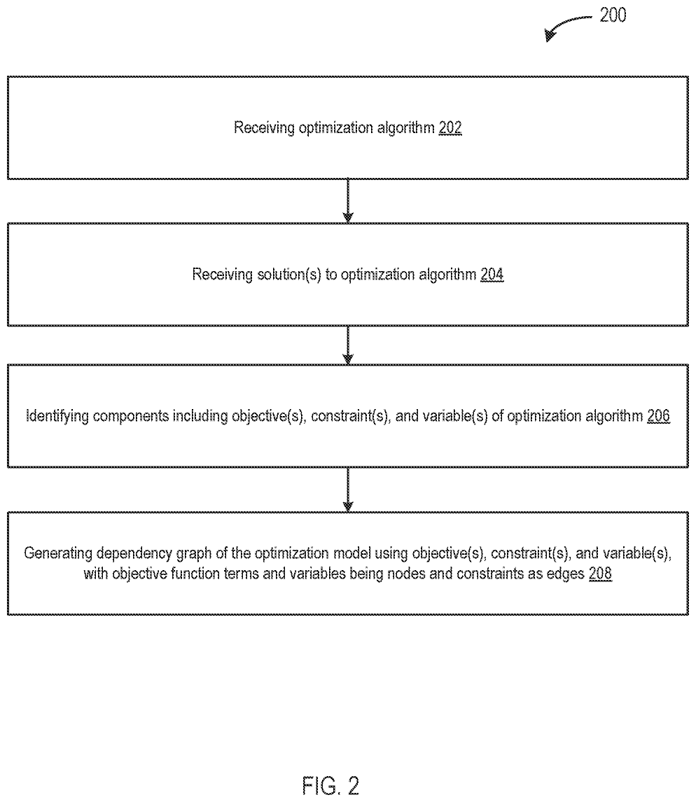

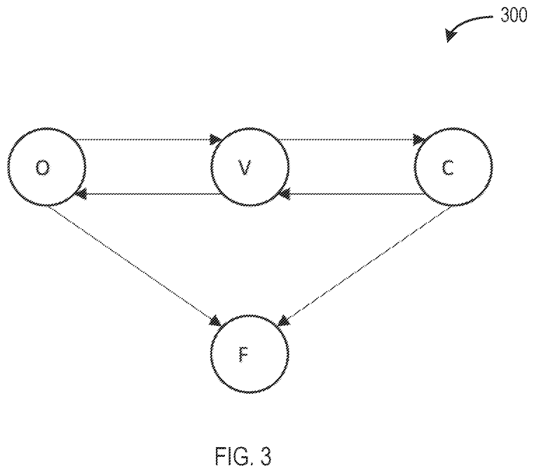

A node may store any number of attributes. For example, a node may store a solver-specific attribute (e.g., pre-solve or post-solve) or entity-specific meta information (e.g., metadata). A solver-specific attribute may include, for example, defaults, optimal value, shadow costs/prices, whether or not a variable is at one of its bounds (e.g., lower or upper), and/or whether or not an inequality constraint is active. Entity-specific meta information may include, for example, the meaning of a variable/constraint in a context (e.g., a “to string” function translating the variable/constraint into human-readable text). The context may be a technical context, business context, and/or the like. It will be appreciated that each node may include any number of attributes and/or meta information in addition to or instead of those described herein. The dependency graph is further discussed herein, particularly with regard to FIG. 2 and FIG. 3.

The query module 110 may receive a query from a user or system (e.g., via the communication module 104). The query may be or indicate a question regarding the optimization model and/or solution of the optimization model. For example, a query may be “Why is a variable negative” (or zero, or positive). In another example, the query may be why one solution is better than another or why a given solution is infeasible. The query module 110 may identify one or more issues from the query. The query module 110 may parse the query and interpret (e.g., using comprehension module 126) the parsed query to identify issues.

The graph traversal module 112 may generate a node representing an “issue” associated with the query. The root node is the beginning from where the dependency graph is traversed to provide information regarding the query. From the root note, the graph traversal module 112 traverses the dependency graph. The graph traversal module 112 may traverse different paths of the dependency graph starting with the root node until: (1) an objective term and/or constraint node is connected by an edge to a field node, and (2) along the path from the root node to that field node, all slack or panic variables are positive. Recall that slack or panic variables and related “soft” constraints allow solutions that deviate from the “hard” constraints but are discouraged from doing so. In some implementations, a slack variable (or, simply, slack) is a variable that is added to an inequality constraint to transform it into an equality. Introducing a slack variable can replace an inequality constraint with an equality constraint and a non-negativity constraint on the slack variable.

The explainability graph module 114 utilizes the dependency graph to assist in answering queries about a solution to the optimization model (e.g., solutions to the underlying problem). The graph traversal module 112 reviews (e.g., reverses) the traversal path(s) to construct an “explanation” (or explanation information) related to the issue identified in the query. In one example, the graph traversal module 112 may collect information related to nodes and edges along the path of traversal (i.e., from the root node until the field node) from cache and/or the dependency graph. In some embodiments, the graph traversal module 112 may collect information from other types of memory (e.g., persistent memory, non-volatile memory, datastores, etc.).

The explainability graph module 114 may generate an explainability graph (e.g., an explainability tree) based on the dependency graph by pruning nodes and edges. In some implementations, when constructing the explanation tree, the explainability graph module 114 may prune the dependency graph using the nodes' attributes. The explainability report module 116 may provide reports or output related to explanation(s), information related to explanation(s), or an indication that there is insufficient information (e.g., that no explanation or information related to an explanation has been found). The explainability report module 116 may provide information (e.g., to a user and/or system) through text, an interactive user interface, report, email, phone call (e.g., automated), and/or the like.

The visualization module 118 may provide an explanation tree to a digital device through an interface, platform, and the like. In some implementations, the explanation tree may be interactive. For example, a user or system may be able to select one or more nodes, inspect attributes, related information of the explanation tree and generate new queries for explanations.

The ordering module 120 may order, rank, sort, and/or filter multiple explanations (or explanation information) associated with one or more queries of the same dependency graph. The explainability report module 116 and/or the visualization module 118 may provide the ordered explanations or explanation information to one or more users or systems.

The memory optimization module 122 may assist with scaling and speed of providing explanations by caching visited nodes (e.g., attributes of nodes) through the dependency graph traversal process. By caching the nodes over the path(s) to find a termination, the explanation information is more readily available at a significant improvement in speed. Further, this provides considerable savings in computing resources.

The retriever module 124 may retrieve relevant information (e.g., based on a similarity analysis and a relevance threshold value) associated with a query. For example, the retriever module 124 may retrieve relevant logs corresponding to the query. The retriever module 124 enables converting a query specifying a particular optimization run to fetch the exact logs for that run using an embedding based similarity search. The retriever module may include one or more machine learning models.

The comprehension module 126 may generate explanation information (e.g., a natural language explanation). More specifically, the comprehension module 126 can be fed the retrieved information (e.g., raw optimization logs) as a prompt paired with the query. The comprehension module 126 can use autoregressive prediction to generate the desired output token-by-token. The comprehension module 126 may include machine learning models, large language models, multimodal models, etc. For example, the retrieved information can be provided to an large language model of the comprehension module 126 as a prompt paired with the query.

The result(s) (e.g., explanation information) generated by the comprehension module 126 can be exposed through a graphical user interface (GUI), such as a chat interface (e.g., generated by the visualization module 118), where a user can ask follow-up questions (e.g., queries) and/or provide other follow-up inputs (e.g., instructions). All follow-up inputs can be appended to the existing dialogue between the comprehension module 126 and the user and can be used to maintain conversation context. For example, “Which constraints were violated in the June 13th optimization schedule?”, followed by, “What was the cause for this violation?” can refer to the same conversation thread, pertaining to a particular optimization run.

In one implementation, the retriever module 124 and the comprehension module 126 provide post-processing functionality which is combined with an interactive chat interface (e.g., generated by the visualization module 118) to address OR related follow-up inputs (e.g., questions) to significantly speed up the time to understand the inner workings of the OR solver (e.g., explainability system 102) and/or optimization model, and provide natural language explainability for the end user. For example, a user can ask for the list of constraints that were invalid/violated in the OR run corresponding to “11 Jun. 2023”, which would result in the explainability system 102 fetching the OR logs from the relevant run of the optimization model and prompting a large language model with the user query.

The explainability action module 128 may cause (e.g., trigger) one or more actions to be performed that address the optimization problem, issues identified in the query, and/or an issues in the query response. For example, the explainability action module 128 may trigger an adjustment to a manufacturing process, scheduling maintenance of physical assets (e.g., manufacturing machines), and the like. The explainability action module 128 may also notify users and/or systems of the one or more actions.

In some embodiments, the explainability action module 128 may require approval for performing actions (e.g., particular corrective actions. For example, the explainability action module 128 may require user input (e.g., from a manager) approving, or pre-approving, a corrective action, such as triggering adjustments to physical machines or schedules, before the action can be triggered and/or performed. In some embodiments, the explainability action module 128 provides error handling and version control (e.g., rollback functionality) for the explainability system 102 and/or associated systems (e.g., systems affected by actions triggered by the explainability system 102. For example, if a corrective action causes a degradation in optimization, or fails to improve optimization, the explainability analysis module may automatically (e.g., without requiring user input) and/or manually (e.g., requiring user input) detect the degradation in optimization, or failure to improve optimization (e.g., based on a continuous real-time monitoring of the optimization performance) and selectively roll-back those corrective actions. For example, physical machines may be readjusted back to their initial configuration and/or updated optimization configuration, and that information may be logged by explainability action module 128 for auditing and to inform future optimizations.

In some embodiments, the explainability action module 128 can manage (e.g., create, read, update, delete) and/or enforce information retention policies. The explainability action module 128 can define retention policies for explanations, optimization algorithms/models, dependency graphs, tree structures and/or other information generated by the explainability system 102. In one example, explainability action module 128 can audit optimizations and other outputs generated by the explainability system 102.

The explainability datastore 130 is any storage including any data organization that stores optimization algorithms and/or optimization models, solutions, queries, explanations, explanation information, attributes, explanation trees, and/or the like. In some implementations, explanations and/or optimization algorithms/models may be reviewed, researched, and audited by the explainability action module 128 and/or any number of authorized individuals (e.g., managers), regulators, and/or the like.

It will be appreciated that the methods described herein may apply to a vast variety of optimization problems (i.e., not limited to OR models). For example, at least some implementations described herein may be applied to optimization models, algorithms, or the like.

In various implementations, models can include mathematical models, statistical models, large language models, natural language processing models, machine learning models, generative artificial intelligence models (e.g., large language models, multimodal models), and/or the like. Explainable OR is applied for decision-making problems and practical applications. In various implementations, the explainability system 102 may be any digital device. A digital device is a computing apparatus (e.g., a computer) with memory and a processor.

FIG. 2 depicts a flowchart 200 of an example method of generating an undirected graph based on an optimization algorithm (e.g., OR model) according to some implementations. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

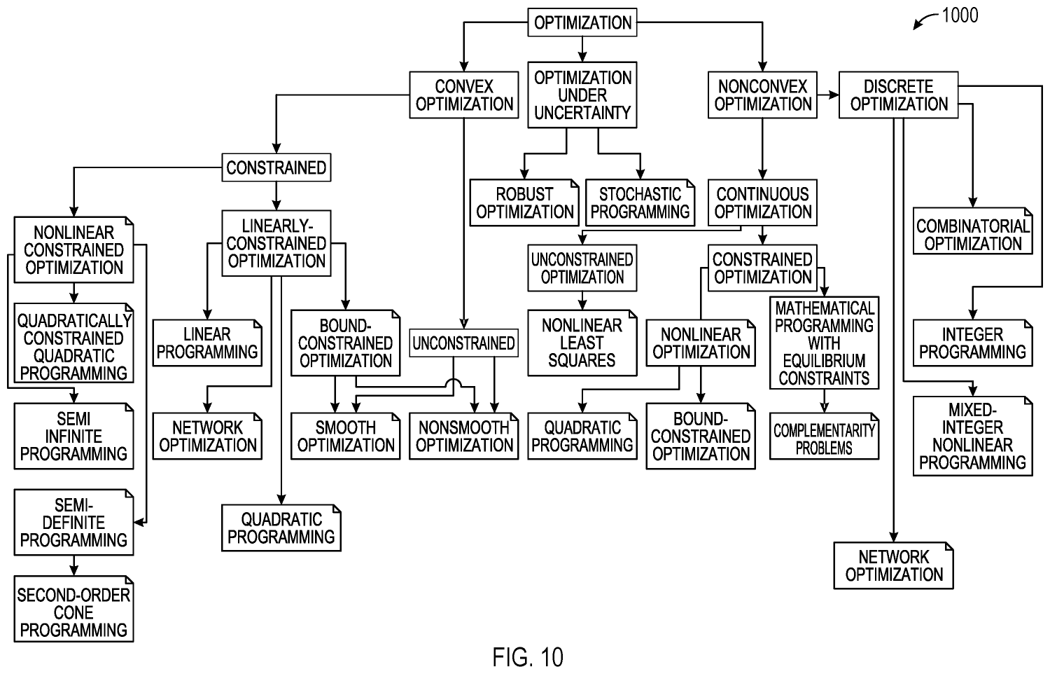

In step 202, the communication module 104 receives an optimization model (e.g., an optimization algorithm). In one example, the optimization model may model a “real world” technical problem (e.g., a technical problem in enterprise management). For simplicity in an example, the communication module 104 receives a mixed integer linear program (MIP). Although MIPs are discussed herein, the systems and methods discussed herein may be applied to other problem domains. An example taxonomy of a broader set of optimization problems are shown in FIG. 10. In the example of FIG. 2, the MIP has the following structure:

$$Minimize / Maximize {v}^{T} x + {w}^{T} y$$

$$Subject to f ( x , y ) \leq 0 ,$$

$$g ( x , y ) = 0 ,$$

where x and y are decision variables, w and v are their respective weights in the objective, the function ƒ includes inequality constraints, and the function g includes equality constraints.

The set of decision variables, x and y, are distinguished so as to differentiate between ordinary variables (represented by x) and “slack” or “panic” variables (represented by y). This is a common problem structure in many business applications: the ordinary variables x and related “hard” constraints represent logic (e.g., business logic) that must be followed; the panic or slack variables y and the related “soft” constraints represent the business' modus operandi from which solutions are allowed to deviate but they are discouraged to do so. The latter is being realized through the use of weights (or, in this case, penalties) w. If the objective direction is to minimize, then w>0; if the objective direction is to maximize, then w<0.

In step 204, the communication module 104 receives one or more solutions for the optimization model. In some implementations, the communication module 104 receives the optimization model that is configured for one or more solutions. In various implementations, the communication module 104 may receive separate information indicating one or more solutions. In some implementations, the explainability system 102 may be configured to assist in solving the optimization model.

In step 206, the analysis module 106 identifies the objectives, constraints, and variables of the optimization equation. For example, the analysis module 106 identifies the objectives, constraints, and variables (e.g., ordinary variables and related “hard” constraints that must be followed as well as the panic or slack variables and the related “soft” constraints that are allowed to deviate).

In step 208, the dependency graph module 108 generates a dependency graph based on the objectives, constraints, and variables identified by the analysis module 106. The dependency graph module 108 generates nodes that represent objective terms (O), variables (V), constraints (C), and fields/parameters (F).

In some implementations, if a variable participates in an objective term/constraint, then corresponding bidirectional edge (e.g., an “arc”) exists between the variable node and the objective term node or constraint node in the dependency graph. If an objective term or a constraint uses a field, a one-directional (e.g., objective term/constraint to field) edge exists between the variable term node or the constraint node and the field node in the dependency graph.

FIG. 3 depicts a diagram 300 of an example dependency graph for the MIP described with regard to step 202. Edges (e.g., arcs) are of the type:
(O, V) resp. (O, F) if an objective O uses a variable V resp. a field F.
(V, O) resp. (V, C) if a variable V participates in an objective O resp. a constraint C.
(C, V) resp. (C, F) if a constraint C uses a variable V resp. a field F.

The dependency graph includes objective terms, variables, and constraints that are connected. As a result, in some implementations, the dependency graph is connected and can be large.

The dependency graph module 108 may store or link attributes associated with one or more nodes. Attributes may include, but is not limited to, the following examples:
(a) Solver-specific attributes (e.g., pre-solve and post-solve) such as defaults, optimal value, shadow costs/prices, whether or not a variable is at one of its bounds (e.g., lower or upper), and/or whether or not an inequality constraint is active; and
(b) Entity specific (e.g., business-specific) meta information such as the meaning of a variable/constraint in the business context (e.g., a “to string” function translating the variable/constraint into human-readable text).

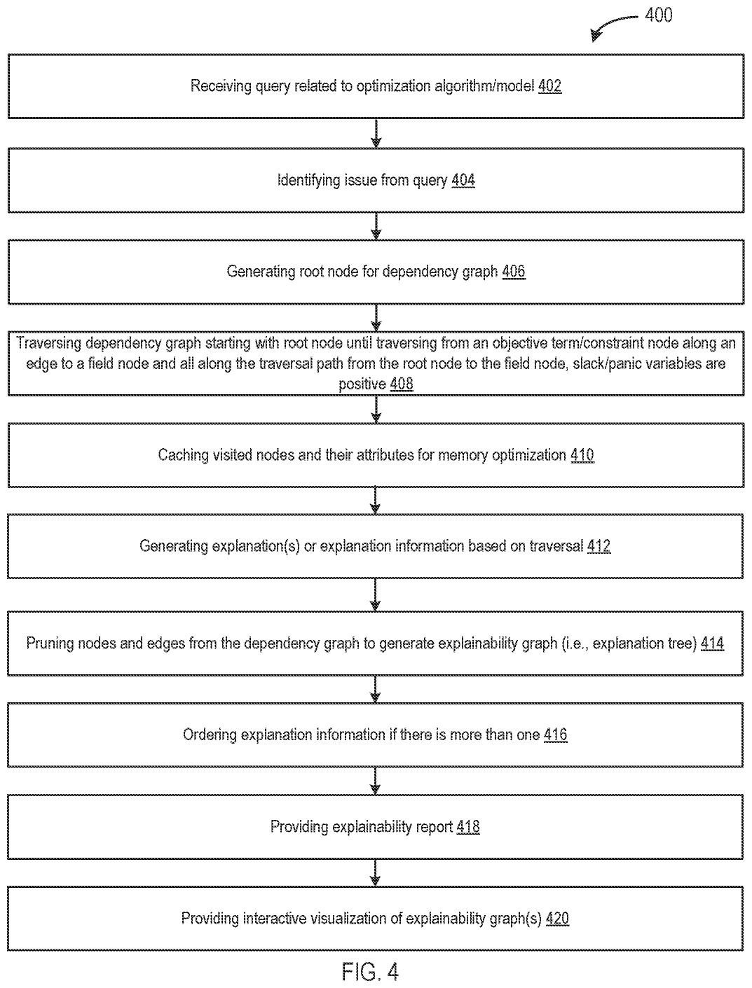

FIG. 4 depicts a flowchart 400 of a method for providing explanation information regarding an optimization algorithm based on the dependency graph in some implementations. In step 402, the query module 110 may receive or identify one or more queries related to the optimization algorithm/model. For example, the query module 110 may receive a query from a user or system (or retrieve one or more standard or previously identified queries) such as:
Why is an objective term/variable positive/negative?
Why is a variable positive/negative?
Why is an inequality constraint active/inactive? In one example, active meaning “=” in the case of a “<” or a “>” constraint.

In step 404, the query module 110 may, in some implementations, translate one or more queries into “issues.” In step 406, the graph traversal module 112 generates a node representing an “issue” associated with the query (e.g., an issue identified by the query module 110 in step 404). The root node is the beginning from where the dependency graph is traversed to provide information regarding the query.

In step 408, the graph traversal module 112 traverses the dependency graph starting from the issue (i.e., root node). The graph traversal module 112 may, for example, attempt to reach a field node without degree 0. The graph traversal module 112 may traverse different paths of the dependency graph starting with the root node until: (1) an objective term and/or constraint node is connected by an edge to a field node, and (2) along the path from the root node to that field node, all slack or panic variables are positive. Recall that slack or panic variables and related “soft” constraints allow solutions that deviate from the “soft” constraints but are discouraged from doing so.

In some implementations, an explanation cannot be found if along the traversal path the graph traversal module 112 visits inactive constraints. In one example, the traversal through the dependency module may terminate in those conditions. In this example, the explainability report module 116 may provide an indication that there is insufficient information for explanation or there is no information. In some implementations, under these conditions, the explainability report module 116 may provide only limited information based on any active constraints or positive information, even if the limited information falls short of providing explanation.

In step 410, since the graph is large, the memory optimization module 122 may cache previously visited nodes along the paths traversed. The memory optimization module 122 may cache or otherwise track visited nodes including the status or attributes of visited nodes to determine an explanation or explanation information. By caching the visited nodes, the explainability system 102 may be able to scale and provide faster responses to queries, faster traversal dependency graphs, and faster generation of explanation(s) and/or explanation information. In some embodiments, the memory optimization module 122 may store information using other methods instead of, or in addition to, caching. For example, the memory optimization module 122 may store previously visited nodes along the paths traversed in cache memory and/or other types of memory (e.g., persistent memory, non-volatile memory, datastores, etc.).

In step 412, once the graph traversal module 112 completes traversal of the dependency graph (e.g., starting with the root node until: (1) an objective term and/or constraint node is connected by an edge to a field node, and (2) along the path from the root node to that field node, all slack or panic variables are positive), the graph traversal module 112 reviews (e.g., reverses) the traversal path(s) to construct an “explanation” (or explanation information) related to the issue identified in the query. In one example, the graph traversal module 112 may collect information related to nodes and edges along the path of traversal (e.g., from the root node until the field node) from cache (and/or other type of memory) and/or the dependency graph.

It will be appreciated that there may be multiple explanations or different explanation information for a specific issue. In one example, a single issue starting with a single root node may have two or more separate paths leading to different objective terms and/or constraint nodes that are connected by an edge to a different field node (and all along both paths from the root node, all slack or panic variables are positive). In that circumstance, the graph traversal module 112 may generate explanations and/or explanation information for each different path traversed to the different field nodes.

In some implementations, there may be multiple issues and/or multiple queries, each of which may be related to one or more different explanation(s) and/or different explanation information. In step 414, the explainability graph module 114 may generate an explainability graph (e.g., an explainability tree) based on the dependency graph by pruning nodes and edges. In some implementations, when constructing the explanation tree, the explainability graph module 114 may prune the dependency graph using the nodes' attributes. For example, if an inequality constraint is inactive (a “<” constraint is satisfied with “<” and not “=”), the explainability graph module 114 may not find an explanation in this branch of the tree and so the explainability graph module 114 may prune the node and related edge.

In step 416, the explainability report module 116 may order explanations if there is more than one explanation (or may order explanation information if there is different information related to different paths). The explainability report module 116 may order based on information provided by the users or systems (e.g., regarding different aspects or metadata of importance to the user/system or the query). The information provided for ordering may be found with or in addition to the query.

In some implementations, the explainability report module 116 may utilize preferences (e.g., user preferences, system preferences) and/or a resolving ties approach to order explanations. In one example, a user/system may prefer (e.g., there may be a user/system preference indication) shorter explanations over longer ones. The explainability report module 116 may take such preferences into account when returning root node to leaf paths from the explanation tree. In another example, there may be multiple paths to which the same preferences are assigned. In this case, the explainability report module 116 may take into account solver meta information to break ties. For example, a constraint's shadow cost may be used to break ties. It will be appreciated that the explanations and/or explanation information may be ordered, sorted, filtered, and/or the like in many ways.

In some implementations, there may be multiple different explanations or explanation information but the explainability report module 116 may not provide any order. In step 418, the explainability report module 116 may provide reports or output related to explanation(s), information related to explanation(s), or an indication that there is insufficient information (e.g., that no explanation or information related to an explanation has been found). The explainability report module 116 may provide the explanation, explanation information, or indication of insufficient information (e.g., “no explanation”) through text (e.g., to another system and/or user), an interactive user interface, report, email, phone call (e.g., automated), and/or the like. The reports or outputs may include the explanations and/or explanation information in the order determined in step 416 (if there is more than one).

In step 420, the visualization module 118 may provide a visualization of the explainability graph. For example, the visualization module 118 may provide the explainability graph to a smartphone app, web site, platform, or the like. In some implementations, the explainability system 102 provides or is a part of a platform and the visualization module 118 provides an interactive explainability graph to allow the user/system to inspect explanations, the explainability graph, underlying values of the explainability graph, generate new queries, and/or the like.

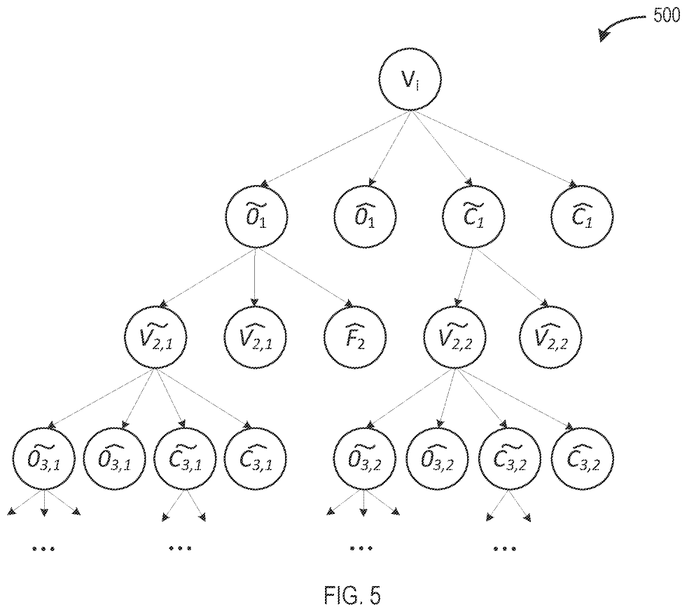

FIG. 5 depicts a diagram 500 of an explanation tree according to some implementations. In the example of FIG. 5, the root node of the investigation is a variable Vᵢ. It is linked to some objective terms that can be pruned (Ô₁) and some that cannot (Õ₁). Similarly, it is linked to some constraints that can be pruned Ĉ₁ and some that cannot \tilde{C}₁. For those nodes that cannot be pruned, the explainability graph module 114 and/or the graph traversal module 112 may traverse the dependency graph further, finding more variables, fields, and/or the like.

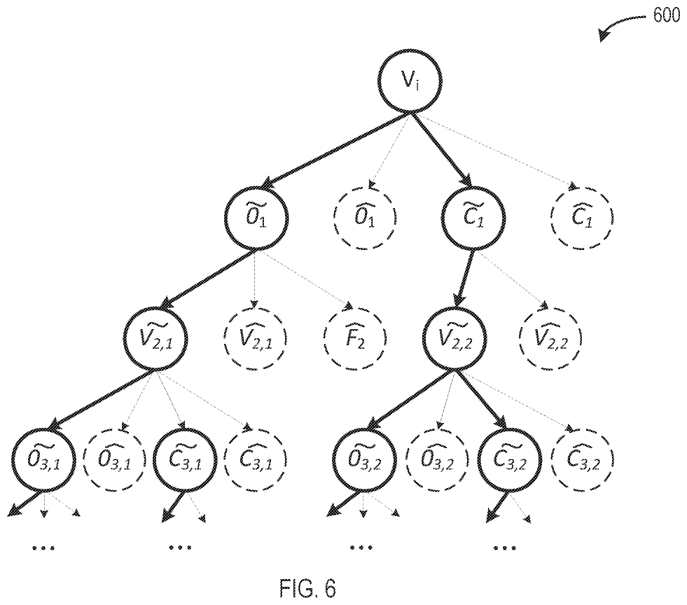

FIG. 6 depicts a diagram 600 of the example explanation tree with nodes and paths that may be pruned as indicated by a dashed line. The paths and nodes with solid bold lines may yield an explanation for the root node, and the paths and nodes indicated in dashed lines do not yield an explanation. For example, the nodes with solid bold lines may indicate an explanation which may be a final result (e.g., if it is a leaf node) and/or an intermediate result (e.g., if it is a non-leaf node). The explanations may include final explanations and/or intermediate explanations (e.g., explanations that may lead to a final result) for the decisions related to (e.g., answering) one or more issues identified in a query. In some embodiments, the nodes indicated in the dashed lines may be nodes that do not indicate any final or intermediate explanations for the decisions related to the one or more issues identified in the query.

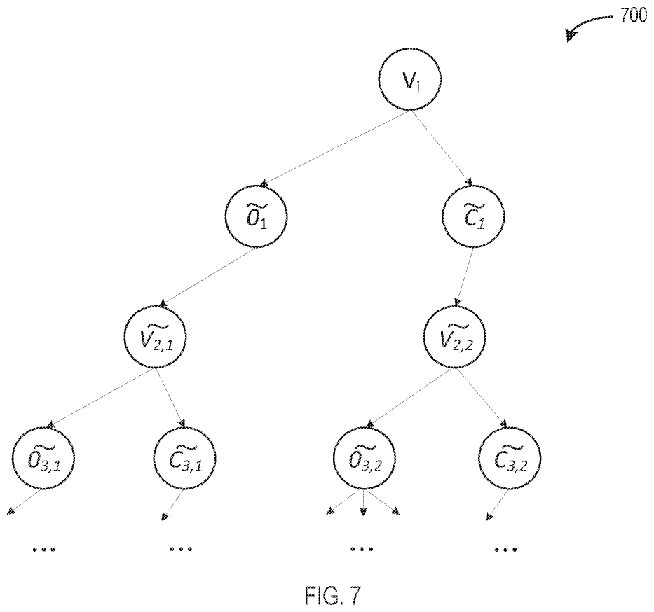

FIG. 7 depicts a diagram 700 of the example explanation tree with only nodes and paths that cannot be pruned according to some implementations. The explanation tree in FIG. 7 is the explanation tree depicted in FIG. 6 but with the prune-able paths and nodes removed. As discussed elsewhere herein, the explainability graph module 114 may generate an explainability graph (e.g., an explainability tree) based on a dependency graph by pruning nodes and edges. For example, if an inequality constraint is inactive (a “S” constraint is satisfied with “<” and not “=”), the explainability graph module 114 may not find an explanation in this branch of the tree and so the explainability graph module 114 may prune the node and related edge. Accordingly, for example, the explanation tree of FIG. 7 may only include the nodes that are traversed to generate the explanations of the decisions of the optimization. This may, for example, reduce memory requirements (e.g., for storing the tree), reduce the size of the graph or tree to satisfy a model input (e.g., prompt for an omni-modal model or large language model), and/or the like.

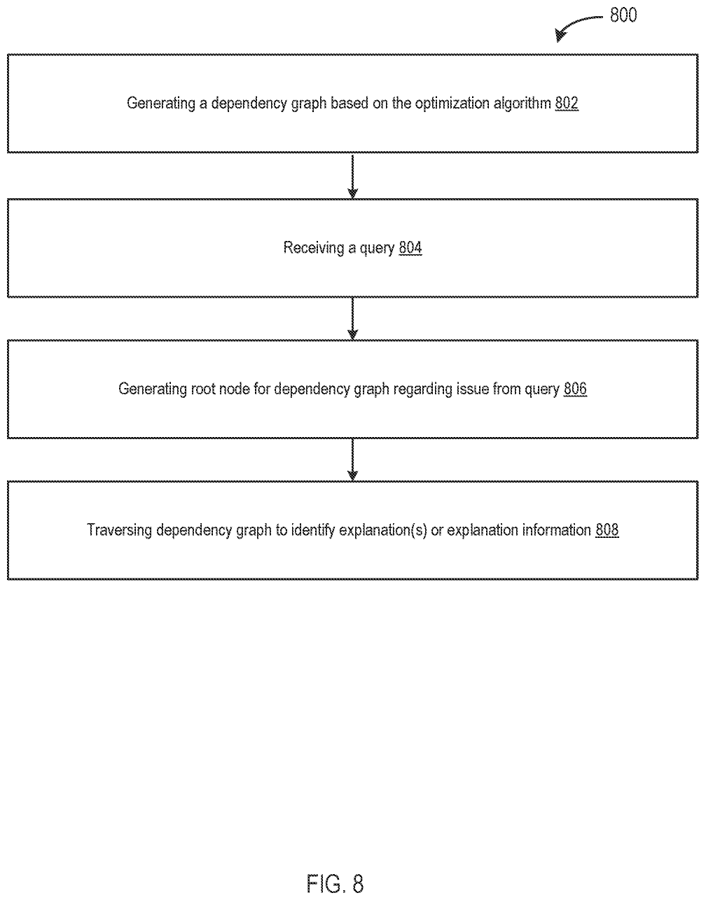

FIG. 8 depicts a flowchart 800 of a method for providing explanation information regarding a large pharmaceutical manufacturer optimization algorithm in an example. The large pharmaceutical manufacturer in this example tracks the flow of materials (e.g., perishable goods) through a production network over time. Materials are mixed following pre-defined recipes to form new materials (e.g., new pharmaceuticals). Due to the perishability of goods, materials can expire or go to waste (which is not desirable). Some optimal production plans may include wasted materials. The pharmaceutical manufacturer may therefore inquire, “why do I waste material?”

In step 802, the dependency graph module 108 may generate a dependency graph based on the optimization algorithm to reduce waste and a solution to the optimization algorithm. In this example, the communication module 104 receives the optimization algorithm, F and a question (i.e., a query) about the formulation result, Q. The dependency graph module 108 generates the dependency graph G including nodes for fields, variables, constraints, and objectives.

In step 804, the query module 110 receives a query, “why is there waste of “m3” at “t”? It will be appreciated that the query may be written in plain language, pseudo code, or code. The query module 110 may identify an issue associated with the query by translating or reducing the query to one or more issues. In step 806, the graph traversal module 112 generates a root node regarding the issue.

In step 808, the graph traversal module 112 traverses the dependency graph to identify one or more explanations or explanation information. The graph traversal module 112 starts traversal examining variables, constraints and objectives related to the question Q starting with nodes of the neighbor of the root node (the start in graph G). For each node along the path of traversal (e.g., along nodes connected by edges starting with the root node), the graph traversal module 112 traverses the dependency graph visiting nodal neighbors if a terminal node is not found. When reaching a constant node, the graph traversal module 112 iterates all predefined rules to check if the constant node is a terminal node and can be a root cause. Some rules may need to answer sub-questions. The answer to all the sub-questions may be cached (e.g., by the memory optimization module 122) to reduce repeat computation and graph traversing. The answer to all the sub-questions may also be stored in other types of memory instead of, or in addition to, cache (e.g., persistent memory, non-volatile memory, datastores, etc.).

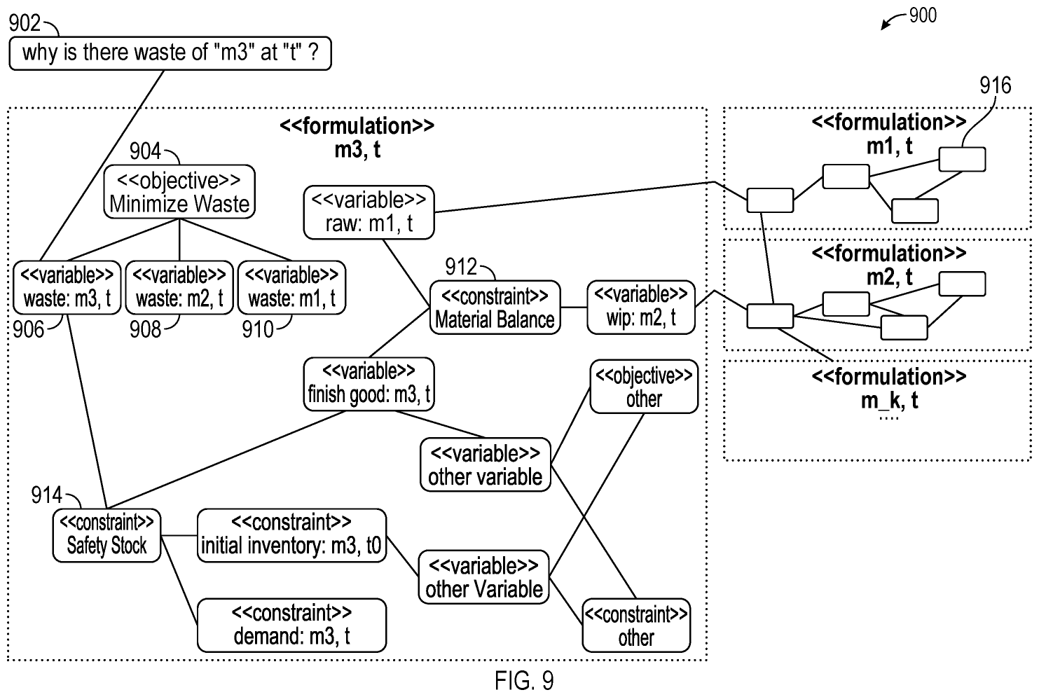

FIG. 9 depicts a diagram 900 of part of a dependency graph for the pharmaceutical manufacturer example including the root node for this example. The full formulation is decomposed by material and time, and only the components related to the target material “m3” at timestamp “t” are shown. In this example, the graph traversal module 112 starts (e.g., in response to query 902) with material waste variables m3 and checks all the other variables m1 (910) and m2 (908) under the minimize waste objective 904. None of those variables m1 (910) or m2 (908) can reach a terminal node 916 (a field), therefore, the graph traversal module 112 cannot explain the waste using those variables m1 (910), m2 (908). The waste variable 906 for “m3” can also reach the safety stock constraint 914, from where the graph traversal module 112 can arrive at a terminal node 916.

The graph traversal module 112 applies a rule-checking logic to determine if this is indeed a root cause of the waste. If not, the graph traversal module 112 may keep tracing to the material balance constraint 912 and apply other terminal condition checks to determine if the waste is due to the material balance constraint 912. In this process, the graph traversal module 112 may reach some variables that have been visited and checked previously through a different objective or constraint. In this case, the explainability report module 116 uses the result from the previous visit. The report (or output) may include terminal nodes and/or explanations (or explanation information).

There may be any number of rules, checks, and/or logic including, such as missed demand caused by insufficient raw materials, missed demand caused by insufficient recipe materials, missed demand caused by shelf life, missed demand caused by equipment capacity, missed demand caused by dwell time, missed demand caused by rounding values, waste caused by expired initial inventory, waste caused by future demand equals future supply, waste caused by no future demand, waste caused by aggregated consumption and aggregated waste. As an example, the graph traversal module 112 checks the first rule/check, “missed demand caused by insufficient raw materials” at day “t,” for material “m.” If the material is within the procurement window and the input material balance is greater than the requested demand quantity, then a root cause is that there is not enough raw material for demand material “m.”

The following is an example explanation tree (e.g., which may be within an explanation report) for the pharmaceutical manufacturer deployment example:

### Overview:

InsufficientMaterial (day=21, material=synMaterial_021 at synFacility_000 as STOCK, quantity=400.38376709839815)
         |_InsufficientRecipeMaterials (day=21, material=synMaterial_021 at synFacility_000 as STOCK, quantity=400.38376709839815)
               |_InsufficientMaterial (day=20, material=syn Material_021 at synFacility_000 as EXPORT, quantity=400.38376709839815)
                     |_InsufficientRecipeMaterials (day=20, material=synMaterial_021 at synFacility_000 as EXPORT, quantity=400.38376709839815)
         |_InsufficientMaterial (day=19, material=synMaterial_017 at synFacility_000 as STOCK, quantity=1129.0348970591928)
         |_InsufficientRecipeMaterials (day=19, material=synMaterial_017 at synFacility_000 as STOCK, quantity=1129.0348970591928)
         |_InsufficientMaterial (day=18, material=synMaterial_017 at synFacility_000 as EXPORT, quantity=1129.0348970591928)
         |_InsufficientRecipeMaterials (day=18, material=synMaterial_017 at synFacility_000 as EXPORT, quantity=1129.0348970591928)
         |_InsufficientMaterial (day=17, material=synMaterial_008 at syn Facility_000 as STOCK, quantity=1569.3199408401877)
         |_InsufficientRecipeMaterials (day=17, material=synMaterial_008 at synFacility_000 as STOCK, quantity=1569.3199408401877)
         |_InsufficientMaterial (day=16, material=synMaterial_004 at synFacility_000 as STOCK, quantity=2923.9786386444066)
         |_InsufficientRecipeMaterials (day=16, material=synMaterial_004 at synFacility_000 as STOCK, quantity=2923.9786386444066)
         |_Insufficient Material (day=15, material=synMaterial_002 at synFacility_000 as STOCK, quantity=2035.2362582893156)
         |_InsufficientRawMaterial (day=15, material=synMaterial_002 at synFacility_000 as STOCK, quantity=2035.2362582893156)
                     |_Rounding Value (day=18, material=synMaterial_017 at synFacility_000 as EXPORT, quantity=1129.0348970591928)
               |_EquipmentCapacity (day=19, material=synMaterial_017 at synFacility_000 as STOCK, quantity=1129.0348970591928)
         |_EquipmentCapacity (day=21, material=synMaterial_021 at synFacility_000 as STOCK, quantity=400.38376709839815)

It will be appreciated that the optimization model may include many different kinds of optimizations. In various implementations, the explainability system 102 may provide explanations and/or explanation information regarding many different kinds of optimizations. For example, the optimization algorithm/model may be or include (without limitation) any of the following. For example, the optimization algorithm may include convex optimization, optimization under uncertainty, or nonconvex optimization. A convex optimization may be constrained or unconstrained. A constrained optimization may be a nonlinear constrained optimization or a linearly-constrained optimization. A nonlinear constrained optimization may be a semi definite programming problem, a quadratically constrained quadratic programming problem, a semi-infinite programming problem, or a second-order cone programming problem. A linear constrained optimization may be a linear programming problem, a network optimization, a quadratic programming problem, a bound-constrained optimization, a smooth optimization, or a nonsmooth optimization. An optimization under uncertainty may be a robust optimization or a stochastic programming problem. A nonconvex optimization may be a continuous optimization (e.g., a nonlinear least squares), an unconstrained optimization, or a constrained optimization. A constrained optimization may be a nonlinear optimization (e.g., a quadratic programming problem or a bound constrained optimization), or a mathematical programming problem with equilibrium constraints (e.g., complementarity problems). A nonconvex optimization may be discrete optimization such as a combinatorial optimization, integer programming problem, mixed-integer nonlinear programming problem, or a network optimization.

The explainability system 102 described herein provides several technical benefits and advantages over traditional systems. For example, the explainability system 102 can improve product quality/shorter product iterations. User-triggered and/or system-triggered explanations may inform developers about potential formulation issues. This may lead to faster surfacing of bugs, formulation issues, and generally an improved product quality/shorter product iterations. The explainability system 102 may further provide trust and acceptance from non-technical users. Based on some implementations described herein, users, decision-makers, and/or systems may be more likely to accept solutions proposed by the optimization software. The increased solution adoption, in turn, may lead to improved decision-making. The explainability system 102 may also provide developer benefits. For example, at least some implementations described herein provide a helpful tool for end-users and/or systems that helps developers and/or systems understand and communicate solutions. Further, some implementations described can be included as part of debugging tool.

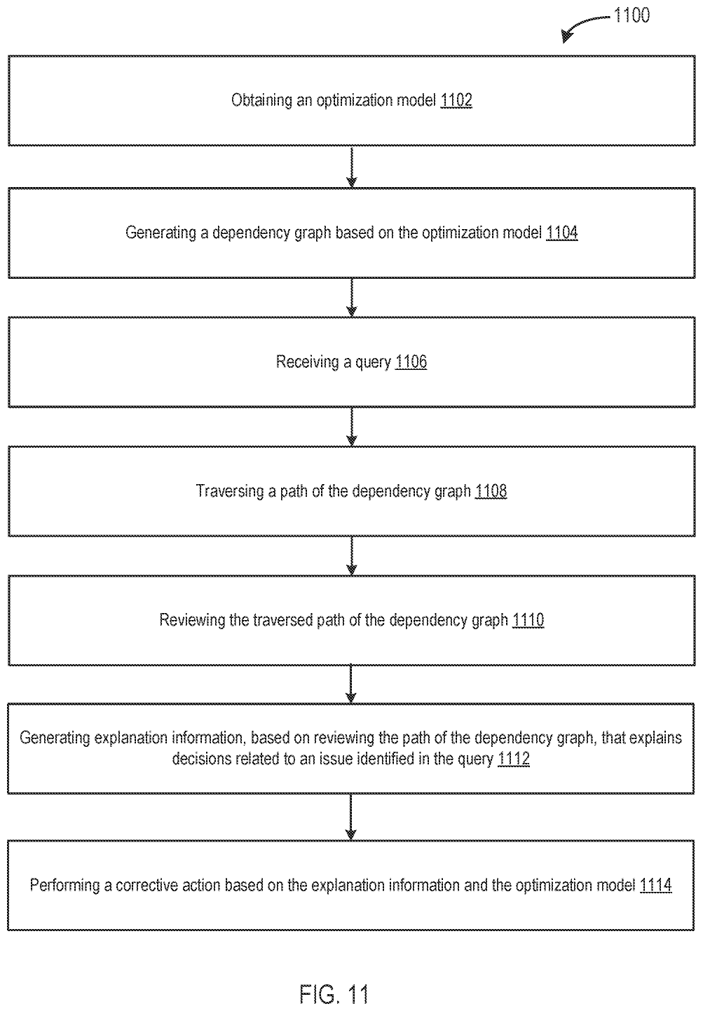

FIG. 11 depicts a flowchart 1000 of a method for providing explanation information regarding an optimization algorithm based on a dependency graph according to some implementations. In step 1102, a computing system (e.g., explainability system 102) generates and/or obtains an optimization model. The optimization model may include one or more objective terms, one or more variables, one or more constraints, and one or more data fields

In step 1104, the computing system generates a dependency graph based on the optimization model. In some embodiments, a dependency graph module (e.g., dependency graph module 108) generates the dependency graph. In step 1106, the computing system receives a query. In some embodiments, a query module (e.g., query module 110) receives the query. In step 1108, the computing system traverses a path of the dependency graph. In some embodiments, a graph traversal module (e.g., graph traversal module 112) traverses the path.

In step 1110, the computing system reviews the traversed path of the dependency graph. The computing system may generate an explanation tree of a reversal to the traversed path of the dependency graph. In some embodiments, an explainability graph module (e.g., explainability graph module 114) reviews the traversed path.

In step 1112, the computing system generates explanation information, based on reviewing the path of the dependency graph, that explains decisions related to an issue identified in the query. For example, the computing system may generate an explanation tree of a reversal to the traversed path of the dependency graph. The explanation information may include the explanation information and/or generated based on the explanation tree. In some embodiments, an explainability report module (e.g., explainability report module 116) and/or a comprehension module (e.g., comprehension module 126) generate the explanation information.

In step 1114, the computing system performs a corrective action based on the explanation information and the optimization model. The corrective action may include adjusting physical equipment of a manufacturing process, adjusting schedules (e.g., production schedules), reassigning or modifying virtual assets, adjusting configurations (e.g., of physical equipment and/or virtual representations of physical equipment), and the like. In some embodiments, an explainability action module 128 performs the corrective action.

In some implementations, the dependency graph includes multiple nodes or sets of nodes, and the nodes includes a root node based on the issue identified in the query, and a node for each of the one or more objective terms, the one or more variables, the one or more constraints, and the one or more data fields. Traversing the dependency graph can include starting from the root node and traversing an edge from a particular objective term node to a particular data field node. Reviewing the traversed path includes reviewing the traversed path from the particular data field node to the root node. Reviewing the path from the particular data field node to the root node may occur if the path from the root node to the particular data field node includes variables that are both positive and slack.

In some implementations, the method 1100 further includes generating a first directional edge between a first node of the plurality of nodes representing a first variable of the one or more variable and a second node of the plurality of nodes representing a first objective term of the one or more objective terms, if the first variable participates the first objective term. The directional edge may indicate a direction from the node representing the particular objective term to the node representing the particular data field. The method 1100 can further include receiving at least one solution to the optimization model, and the dependency graph may be generated based on the optimization model and the at least one solution. The method 1100 can further include providing an interactive visualization of an explainability graph, the explainability graph including the root node and all nodes along the path used to provide the explanation information.

In some implementations, if a particular objective term of the one or more objective terms, represented by a node of the plurality of nodes of the dependency graph, uses a particular data field of the one or more data fields, represented by another node of the plurality of nodes of the dependency graph, then a directional edge can be generated between the node representing the particular objective term and the node representing the particular data field. If a particular constraint of the one or more constraints, represented by a particular node of the dependency graph, uses a particular data field of the one or more data fields, represented by another node of the plurality of nodes of the dependency graph, then generating a directional edge between the node representing the particular constraint and the node representing the particular data field.

In some implementations, if a particular constraint of the one or more constraints, represented by a particular node of the dependency graph, uses a particular variable of the one or more variables, represented by another node of the plurality of nodes of the dependency graph, then generating a directional edge between the node representing the particular constraint and the node representing the particular variable.

In some implementations, the optimization model is associated with one or more optimization problems. For example, the optimization model may be associated (e.g., linked) to one or more particular optimization problems (e.g., a subset of the optimization problems depicted in FIG. 10). The optimization model can include convex optimization, optimization under uncertainty, and/or nonconvex optimization. The convex optimization may be constrained or unconstrained, wherein a constrained optimization may be a nonlinear constrained optimization or a linearly-constrained optimization, wherein a nonlinear constrained optimization may be a semi definite programming problem, a quadratically constrained quadratic programming problem, a semi-infinite programming problem, or a second-order cone programming problem.

In some implementations, the linear constrained optimization may be a linear programming problem, a network optimization, a quadratic programming problem, a bound-constrained optimization, a smooth optimization, or a nonsmooth optimization, wherein the optimization under uncertainty may be a robust optimization or a stochastic programming problem, wherein the nonconvex optimization may be a continuous optimization (e.g., a nonlinear least squares), an unconstrained optimization, or a constrained optimization, wherein a constrained optimization may be a nonlinear optimization (e.g., a quadratic programming problem or a bound constrained optimization), or a mathematical programming problem with equilibrium constraints (e.g., complementarity problems), and wherein the nonconvex optimization may be a discrete optimization such as a combinatorial optimization, integer programming problem, mixed-integer nonlinear programming problem, or a network optimization.

In some implementations, the optimization problem may include a degradation optimization problem. The degradation problem may be associated with any of degradable or perishable components (e.g., food, pharmaceuticals, virtual assets). The perishable components may be determined and/or identified based on countdown timers and/or timestamps. The optimization problem may include pharmaceutical manufacturer optimization problems, food manufacturer optimization problems, virtual asset optimization problem, electronics manufacturer optimization, agriculture harvesting optimization, metallurgy optimization, and vehicle and aircraft manufacturing optimization. In some implementations, generating the explanation information includes using a multimodal model to generate natural language explanation information. The query may be received through an interactive chat interface, and the natural language explanation information may be displayed through the interactive chat interface.

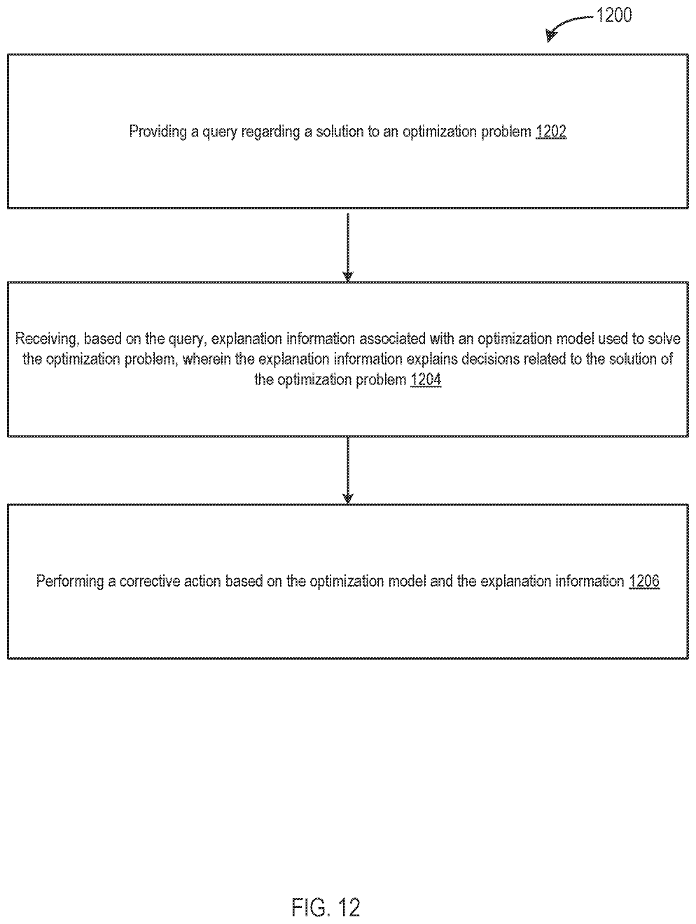

FIG. 12 depicts a flowchart 1200 of a method for performing corrective actions based on explanation information regarding a solution to an optimization algorithm according to some implementations. In step 1202, a client device (e.g., computer used by an end-user) provides a query regarding a solution to an optimization problem. For example, the client device may provide the query to a computing system (e.g., explainability system 102) over a network.

In step 1204, the client device receives, based on the query, explanation information associated with an optimization model used to solve the optimization problem. The explanation information explains decisions related to the solution of the optimization problem. The client may receive the explanation information from the computing (e.g., which may have generated the explanation information). In step 1206, one or more corrective actions are performed based on the optimization model and the explanation information.

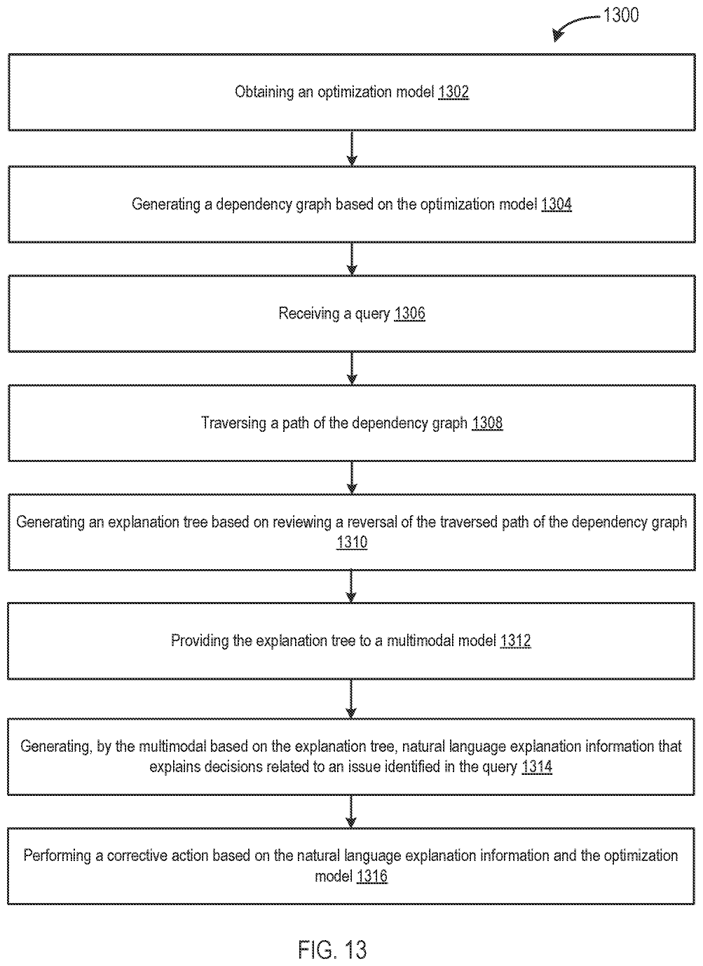

FIG. 13 depicts a flowchart 1300 of a method for using generative artificial intelligence to explain a solution to an optimization problem according to some implementations. In step 1302, a computing system (e.g., explainability system 102) obtains an optimization model. In step 1304, the computing system generates a dependency graph based on the optimization model. In step 1306, the computing system receives a query. In step 1308, the computing system traverses a path of the dependency graph. In step 1310, the computing system generates an explanation tree based on a review of a reversal of the traversed path of the dependency graph. In step 1312, the computing system provides the explanation tree to a multimodal model (e.g., large language model). In step 1314, the computing system generates, by the multimodal based on the explanation tree, natural language explanation information that explains decisions related to an issue identified in the query. In step 1316, a corrective action is performed based on the natural language explanation information and the optimization model.

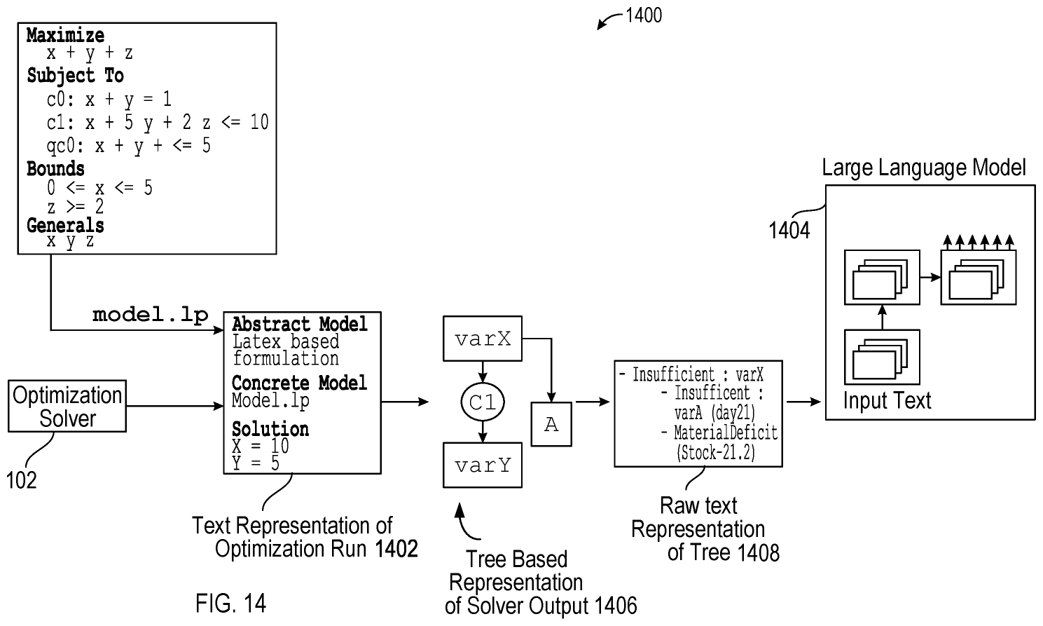

FIG. 14 depicts a diagram 1400 of an example system flow for enterprise artificial intelligence OR explainability according to some implementations. In the example of FIG. 14, the explainability system 102 generates text-based logs corresponding to each run of the optimization model, which contains an identifier (e.g., fingerprint) of the problem statement, formulation and the solution the solver 102 arrived at. These are compiled together and provided to machine learning model 1402 (e.g., large language model or omni-modal model of the comprehension module 126) with a customized prompt to enable natural language querying of the optimization results. The explainability system 102, or portions thereof, may also be referred to as an OR solver 102. In some embodiments, the OR solver may be a separate system (e.g., including portions of the explainability system 102 and/or other modules) that provides outputs to the explainability system 102 for processing.

The text representation 1402 contains three major components, namely, (1) an abstract description of the problem (e.g., math-based formulation that the solver is attempting to solve), (2) The concrete model, such as the LP file, which is the “data realization” of the abstract model, and (3) The OR solver's solution, (e.g., commonly in a SOL file). These provide inputs of different levels of abstractions to the comprehension module 126. The explainability system 102 can also provide the user with a chat interface where the user questions are appended to a prompt.

An example prompt template is as follows:

### Extracts:

{Abstract Model Definition}
{LP Model File}
{SOL File}
User Query: “Why was demand for item XYZ not met on June 11?”
You are an expert operations research scientist. Given the extracts containing the abstract model definition, LP model file, and the extracted solution, answer the “User Query”, using only the information provided in the extracts.

For follow up questions, the user queries can be sequentially appended into the conversation thread, so that follow-up questions maintain the same context.

In the event that the problem description/model is too large for a prompt (e.g., LLM prompt) due to context length limitations, a tree description 1406 and/or 1408 of the solver's output is first extracted through a graph traversal logic. For example, a tree structure may include:
InsufficientMaterial (day=21, material=synMaterial_021 at synFacility_000 as STOCK, quantity=400.38376709839815)
   |_InsufficientRecipeMaterials (day=21, material=synMaterial_021 at synFacility_000 as STOCK, quantity=400.38376709839815)
   |_InsufficientMaterial (day=20, material=synMaterial_021 a at synFacility_000 as EXPORT, quantity=400.38376709839815)
   |_InsufficientRecipeMaterials (day=20, material=synMaterial_021 at synFacility_000 as EXPORT, quantity=400.38376709839815)
   |_InsufficientMaterial (day=19, material=synMaterial_017 at synFacility_000 as STOCK, quantity=1129.0348970591928)

This tree structure 1406 and/or 1408 can be passed as a prompt to the comprehension module 126 (e.g., an LLM of the comprehension module 126), and the comprehension module 126 can use this compiled information to respond to the user query (e.g., generate a natural language summary or response). This tree can be extracted through the same procedures as discussed elsewhere herein.

In another example, a natural language description of a corresponding dependency graph (e.g., of the type depicted in FIG. 9) may be passed to the model 1404 instead of, or in addition to, the tree structure 1406 and/or 1408 (e.g., in the event that the problem description/model and/or tree structure are too large for a prompt). For example, an omni-model or large language model of the comprehension module 126 may generate (e.g., in cooperation with the retriever module 124) the natural language description of the dependency graph, and then generate the prompt based on the natural language description (e.g., the prompt includes the natural language description). The model used to generate the natural language description may be model 1402 and/or other machine learning model (e.g., another instance of the model 1402, or another large language model or omni-modal model).

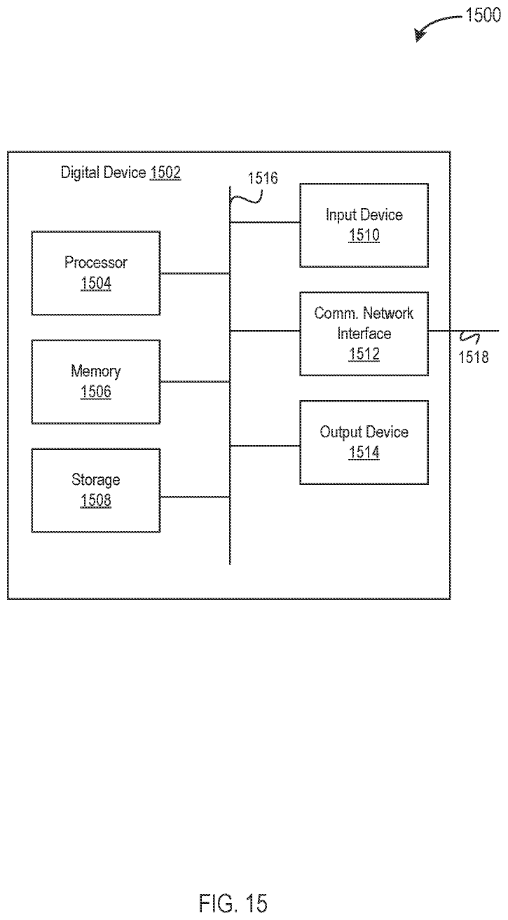

FIG. 15 depicts a diagram 1500 of an example of a computing device 1502. Any of the systems, engines, datastores, and/or networks described herein may comprise an instance of one or more computing devices 1502. In some embodiments, functionality of the computing device 1502 is improved to the perform some or all of the functionality described herein. The computing device 1502 comprises a processor 1504, memory 1506, storage 1508, an input device 1510, a communication network interface 1512, and an output device 1514 communicatively coupled to a communication channel 1516. The processor 1504 is configured to execute executable instructions (e.g., programs). In some embodiments, the processor 1504 comprises circuitry or any processor capable of processing the executable instructions.

The memory 1506 stores data. Some examples of memory 1506 include storage devices, such as RAM, ROM, RAM cache, virtual memory, etc. In various embodiments, working data is stored within the memory 1506. The data within the memory 1506 may be cleared or ultimately transferred to the storage 1508. The storage 1508 includes any storage configured to retrieve and store data. Some examples of the storage 1508 include flash drives, hard drives, optical drives, cloud storage, and/or magnetic tape. Each of the memory system 1506 and the storage system 1508 comprises a computer-readable medium, which stores instructions or programs executable by processor 1504.

The input device 1510 is any device that inputs data (e.g., mouse and keyboard). The output device 1514 outputs data (e.g., a speaker or display). It will be appreciated that the storage 1508, input device 1510, and output device 1514 may be optional. For example, the routers/switchers may comprise the processor 1504 and memory 1506 as well as a device to receive and output data (e.g., the communication network interface 1512 and/or the output device 1514).

The communication network interface 1512 may be coupled to a network via the link 1518. The communication network interface 1512 may support communication over an Ethernet connection, a serial connection, a parallel connection, and/or an ATA connection. The communication network interface 1512 may also support wireless communication (e.g., 802.11 a/b/g/n, WiMax, LTE, Wi-Fi). It will be apparent that the communication network interface 1512 may support many wired and wireless standards.

It will be appreciated that the hardware elements of the computing device 1502 are not limited to those depicted in FIG. 15. A computing device 1502 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1504 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that a “module,” “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It should be understood that some or all of the steps in the flow charts may be repeated, reorganized for parallel execution, and/or reordered, as applicable. Moreover, some steps in the flow charts that could have been included may have been removed to avoid providing too much information for the sake of clarity and some steps that were included could be removed but may have been included for the sake of illustrative clarity.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Aspects of this disclosure can be used with an Enterprise Generative AI framework for unifying information access methodologies and application operations across legacy and new enterprise applications and growing magnitude of data sources in enterprise environments. Example implementations with an Enterprise Generative AI framework can enable harmonizing access to information and increasing availability to complex application operations while respecting enterprise security and privacy controls. The framework can use machine learning techniques to navigate enterprise information and applications, comprehend organization specific context queues (e.g., acronyms, nicknames, jargon, etc.), and locate information most relevant to a request. Example implementations can be used to lower the learning curve and reduce the steps a user must perform to access information thereby democratizing usage of information currently blocked by complexities and domain expertise required by conventional enterprise information systems.

Explainable operations research machine learning techniques can be used to enable an intuitive non-complex interface to rapidly execute complex user requests with improved access, privacy, and security enforcement. Implementations leverage generative AI techniques to enable responses to requests that are provided to users in an intuitive, non-complex manner. An example Enterprise Generative AI framework can include a human computer interface for receiving natural language queries and presenting relevant information with predictive analysis from the enterprise information environment in response to the queries. An enterprise comprehension module (e.g., comprehension module 126) is used to understand the language, intent, and context of a user natural language query. The enterprise comprehension module executes the user natural language query to discern relevant information from the enterprise information environment to present to the human computer interface. The generative AI models interact with one or more of the one or more retrieval models. One or more retrieval models are used for understanding underlying data, documents, and applications of an enterprise information environment. Underlying data of the enterprise information environment can be embedded by an orchestration module, for example, by a model driven architecture for the conceptual representation of enterprise and external data sets for data virtualization and access control. Information presented with predictive analysis can include text summary, ranked results, smart cards, AI-powered chat interface, content generated on-the-fly, etc. The predictive analysis can be from one or more AI applications that include, for example, Supply Chain, CRM, ERP, Reliability, Defense, Sustainability, or Energy, etc.

Explainable operations research machine learning techniques provides transformative practical solutions for optimizing complex problems. Input can be from enterprise users using a natural language interface to rapidly locate, retrieve, and present relevant data across the entire corpus of an enterprise's information systems. Synthetic data or new content generation can refer to content generated on-the-fly as part of the request response. Synthetic data can also include non-retrieved ephemeral content (e.g., temporary data that does not subsist in a database), as well as combinations of retrieved, queried information, model output, etc.

AI applications can include, for example, Supply Chain, CRM, ERP, Reliability, Defense, Sustainability, Energy, etc. AI applications can be capable of processing data pertaining to a real-world systems, devices, scenarios, etc. and analyze the data to derive one or more insights. Generative AI, for example, can aid enterprise logistics operations with logistical uncertainty, such as an inventory module, a prediction module, a simulation module, a tuning module, an optimization module, an aggregation module, an automation module, a control module, etc. An example framework for integrating, processing, and abstracting data related to an enterprise logistics optimization development platform can include tools for machine learning, application development and deployment, data visualization, automated control and instruction, other tools (such as an integration component, a data services component, a modular services component, and an application that may be located on or behind an application module), etc. Enterprise Generative AI aids designing, development, provisioning, and operating a platform for industrial-scale applications in various industries, such as energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

For example, supply chain data may be obtained from a first AI application (e.g., an inventory management and optimization or supply chain application) and the impact information may be obtained based at least in part on the supply chain data and information from another AI application, such as an AI application used to monitor and predict maintenance needs for a fleet of vehicles. In the example, the supply chain data may indicate issues with the supply, another AI application may be used to identify vehicles needing maintenance, and the impact information may represent an insight into how the vehicles needing maintenance are being impacted by issues in the supply chain (e.g., based on the supply chain data). Example information from different data domains or application objects may include key performance metrics (KPIs). From left to right, the examples include a fleet readiness score, unscheduled maintenance avoided (hours) over a time period, a number of flights gained (e.g., due to avoided maintenance), operation time at risk, etc., aircraft status risk score information, component risk score and ranking (e.g., by risk score) information, information associated with AI alerts, flight capability information (e.g., by geographic region), case information, supply chain data, and impact information regarding aircraft being impacted by effects within the supply chain. The ability to obtain insights from one or more AI applications and return those insights provides enhanced accessibility functionality. For example, the impact information may not be obtained from a supply chain application or maintenance application individually.

The outputs can include predictions, insights, or recommendations from the associated AI applications and be in the form of dispatching actions, decision support guidance, inter-platform instruction generation, dynamic dashboard, automated summary charts of critical information, access AI-generated summary answers with references to sources, email briefs, alerts, generic content generation (e.g., proposals), an AI-powered chat interface, ranked list of top results, etc. from the one or more AI applications, open source libraries, document libraries, email systems, etc.

Explainable operations research machine learning techniques may leverage the capabilities of different AI applications to return insights based on outputs of multiple AI applications. It can be used with an Enterprise Generative AI system to provide a powerful new capabilities using a single interface with intelligent interactive features (e.g., chatbot) to recommend actions based on the response to the query. In an example, the retrieval AI model with HCl proposes or responds to workflow tasks/actions via a chatbot interaction that includes generating new recommendations or workflows based on context of a request and/or knowledge base resources. For example, a supply chain request about ‘from which location can I get an xyz engine to Guam?’, the Enterprise Generative AI system can create a new recommendation with a workflow and prompt “would you like to have the part sent?” to further trigger an instruction to one or more enterprise applications or information systems. Various responsive context based dispatching actions, recommendations, or tasks/actions can be created (e.g., e-mails, order/inventory management, maintenance, etc.) and dynamic interface generation responsive to workflow-related search results (i.e., launch e-mail application with data populated in body of e-mail related to or derived from search as part of workflow; display workflow on dynamic web page responsive to activation of workflow search results element, etc.). The interaction elements can include predictions, insights, or recommendations from the associated AI applications and be in the form of, for example, dispatching actions, decision support guidance, inter-platform instruction generation, etc. from the one or more AI applications, open source libraries, document libraries, email systems, etc.

A feedback module can be used to enable tuning and learning by the enterprise comprehension modules. For example, the feedback module may tune the generative AI module based on tracking user interactions within the system, capture explicit feedback (e.g., through a training user interface), implicit feedback, etc. In some example implementations, a reinforcement learning module can optionally be used to accelerate knowledge base bootstrapping. Reinforcement learning can be used for explicit bootstrapping of the system with instrumentation of time spent, results clicked on, etc. Example aspects include an innovative learning framework that can bootstrap models for different enterprise environments. Example aspects include an innovative learning framework that can bootstrap models for different enterprise environments.

A request can be input various natural forms for easy human interaction (e.g., basic text box interface, image processing, voice activation, etc.) and processed to rapidly find the relevant and responsive information. Enterprise Generative AI summarizes the relevant comprehensive answers (e.g., text summary, ranked results, smart cards, etc.), generates new insight content, and presents interactive results for users in a transparent manner. For example, each request response can include a list of search results ranked by relevance-across documents, web pages, and applications. Enterprise Generative AI can be used to manage all relevant access-controls and enterprise security requirements to ensure that users are only able to see the documents and results that they have the permissions to access and view. With both cloud-native and air-gapped deployment availability, Enterprise Generative AI addresses unique security and scalability requirements across a wide range of industries and use cases. Enterprise Generative AI can be deployed as part of a stand-alone application and/or integrated into existing enterprise applications and platforms, including for example, C3 AI Platform or with C3 AI applications such as C3 AI Reliability, C3 AI Supply Chain, C3 AI Sustainability, C3 AI CRM, C3 AI ERP, C3 AI Defense, C3 AI Energy, among others.

In general, the routines executed to implement the embodiments of the present disclosure can be implemented as part of an operating system or a specific application, component, program, object, module or sequence of instructions referred to as “programs” or “applications”. For example, one or more programs or applications can be used to execute specific processes described herein. The programs or applications typically comprise one or more instructions set at various times in various memory and storage devices in the machine and that, when read and executed by one or more processors, cause the machine to perform operations to execute elements involving the various aspects of the embodiments described herein.

Example types of processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

Example embodiments of the explainable operations research machine learning systems and methods disclosed herein can be used with AI decision-making optimization applications. In some example implementations explainable operations research machine learning modeling can be used with a model-driven architecture that includes a type system.

A model-driven architecture is a term for a software design approach that provides models as a set of guidelines for structuring specifications. An example model-driven architecture may include a type system that may be used as a domain-specific language (DSL) within a platform used to access data, interact with data, and/or perform processing or analytics based on one or more type or function definitions within the type system. By using an abstraction layer provided by a type system, the complexity of a logistics optimization application problem can be reduced by orders of magnitude, such as to the order of a few thousand types, for any given logistics optimization application that a programmer manipulates using JAVASCRIPT or other language to achieve a desired result. Thus, all of the complexity of the underlying foundation (with an order of M×S×T×A×U using structured programming paradigms) is abstracted and simplified for the programmer. Here, M represents the number of process modules (APACHE Open Source modules are examples of process modules), S represents the number of disparate enterprise and extraprise data sources, T represents the number of unique sensored devices, A represents the number of programmatic APIs, and U represents the number of user presentations or interfaces. Example technologies that can be included in one or more embodiments may include nearly-free and unlimited compute capacity and storage in scale-out cloud environments, such as AMAZON Web Services (AWS); big data and real-time streaming; smart connected devices; mobile computing; and data science including big-data analytics and machine learning to process the volume, velocity, and variety of big-data streams.

The type system of the model-driven architecture may include types as data objects and at least one of: associated methods, associated logic, and associated machine learning classifiers. One or more of the data objects may be associated with at least one of: one or more customers, one or more companies, one or more accounts, one or more products, one or more employees, one or more suppliers, one or more opportunities, one or more contracts, one or more locations, and one or more digital portals. Type definitions may include properties or characteristics of an implemented software construct.

Employing the type system of the model-driven architecture may include performing data modeling to translate raw source data formats into target types. Sources of data may be associated with at least one of: accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, and service logs. Among other things, the type system can be employed to perform data modeling in order to translate raw source data formats into target types. Sources of data for which data modeling and translation can be performed may include accounts, products, employees, suppliers, opportunities, contracts, locations, digital portals, geolocation manufacturers, SCADA information, OMS information, inventories, supply chains, bills of materials, transportation services, maintenance logs, or service logs.

The model-driven architecture enables capabilities and applications including precise predictive analytics, massively parallel computing at the edge of a network, and fully-connected sensor networks at the core of a business value chain. The model-driven architecture can serve as the nerve center that connects and enables collaboration among previously-separate business functions, including product development, marketing, sales, service support, manufacturing, inventory, finance, shipping, order management, human capital management, etc. Some embodiments may include a product cloud that includes software running on a hosted elastic cloud technology infrastructure that stores or processes product data, customer data, enterprise data, and Internet data. The product cloud may provide one or more of: a platform for building and processing software applications; massive data storage capacity; a data abstraction layer that implements a type system; a rules engine and analytics platform; a machine learning engine; smart product applications; and social human-computer interaction models. One or more of the layers or services may depend on the data abstraction layer for accessing stored or managed data, communicating data between layers or applications, or otherwise storing, accessing, or communicating data.

The model-driven architecture may operate as a comprehensive design, development, provisioning, and operating platform for industrial-scale applications in various industries, such as energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

An integration component, data services component, and modular services component may store, transform, communicate, and process data based on the type system. In some embodiments, the data sources and/or the applications may also operate based on the type system. In an example embodiment, the applications may be configured to operate or interface with the components based on the type system. For example, the applications may include business logic written in code and/or accessing types defined by a type system to leverage services provided by the system.

In some embodiments, the model-driven architecture uses a type system that provides type-relational mapping based on a plurality of defined types. For example, the type system may define types for use in the applications, such as a type for a customer, organization, device, or the like. During development of an application, an application developer may write code that accesses the type system to read or write data to the system, perform processing or business logic using defined functions, or otherwise access data or functions within defined types. In some embodiments, the model-driven architecture enforces validation of data or type structure using annotations/keywords. The types in the type system may include defined view configuration types used for rendering type data on a screen in a graphical, text, or other format. In some embodiments, a server, such as a server that implements at least a portion of the system, may implement mapping between data stored in one or more databases and a type in the type system, such as data that corresponds to a specific customer type or other type.

One example of a type system is given by way of the following non-limiting example, which may be used in various embodiments and in combination with any other teachings of this disclosure. In some embodiments, the fundamental concept in the type system is a “type,” which is similar to a “class” in object-oriented programming languages. At least one difference between “class” in some languages and “type” in some embodiments of the type system disclosed here is that the type system is not tied to any particular programming language. As discussed here, at least some embodiments disclosed here include a model-driven architecture, where types are the models. Not only are types interfaces across different underlying technologies, but they are also interfaces across different programming languages. In fact, the type system can be considered self-describing, so below is presented an overview of the types that may define the type system itself.

A type is the definition of a potentially-complex object that the system understands. Types may be the primary interface for all platform services and the primary way that application logic is organized. Some types are defined by and built into the platform itself. These types provide a uniform model across a variety of underlying technologies. Platform types also provide convenient functionality and build up higher-level services on top of low-level technologies. Other types are defined by the developers using the platform. Once installed in the environment, they can be used in the same ways as the platform types. There is no sharp distinction between types provided by the platform and types developed using the platform.

The logistics optimization application can be used with various enterprise functions, such as messaging, reporting, alerting, etc. processes to update systems based on triggers, detecting anomalies, real-time data streams, etc. In example enterprise environments, the logistics optimization application can control or instruct manufacturing or resource planning systems.

It will be appreciated that pharmaceutical manufacturing is one example described herein, and the systems and methods described herein may be applicable to other examples and/or environments, such as food manufacturing and/or other types of manufacturing and/or processing. In some implementations, the systems and methods described herein may be particularly applicable to any environment(s) with degrading (e.g., perishable) components. For example, this can include the aforementioned pharmaceutical and food examples, and/or virtual components. For example, virtual assets (e.g., NFTs) may be degradable (e.g., as determined by a countdown timer, timestamps, etc.).

It may be apparent to those skilled in the art that various modifications may be made and other implementations may be used without departing from the broader scope of the discussion herein. Therefore, these and other variations upon the example implementations are intended to be covered by the disclosure herein.

Various implementations of the present disclosure include systems, methods, and non-transitory computer-readable media configured to provide explanations and/or explanation information for the operations and/or choices associated with an optimization model (e.g., generated by an optimization algorithm). The optimization model may include objective terms, variables, constraints, and fields (e.g., data fields) that may be identified as nodes in a dependency graph. Directional edges may connect nodes of the dependency graph (e.g., a variable node may be connected to an objective term node, if the variable participates in the objective term). The dependency graph may be traversed to find an explanation or explanation information related to a particular query on the functioning of the optimization model starting with a root node that represents an issue identified in the query. The dependency graph may be traversed starting from a root node until traversing an edge from a particular objective term node to a particular field node and until the path from the root node to the particular field node include variables that are positive. Subsequently, the path's direction from the particular field node to the root node is reviewed to generate explanation information that explains decisions related to the issue identified in the query related to the optimization model. The explanation and/or explanation information may be provided to a digital device (e.g., a device of a user or other entity).

In some implementations, reviewing the path from the particular field node to the root node occurs if the path from the root node to the particular field node includes variables that are both positive and slack. In some implementations, a slack variable is a variable that allows the model to satisfy inequality and/or equality constraints that would otherwise be violated without the presence of such a variable.

Various implementations may further comprise receiving at least one solution to the optimization model, the dependency graph being generated based on the optimization model and the at least one solution. Some implementations may further comprise providing an interactive visualization of an explainability graph, the explainability graph including the root node and all nodes along the path used to provide the explanation information. If a particular objective term of the one or more objective terms, represented by a node of the plurality of nodes of the dependency graph, uses a particular field (e.g., particular data field) of the one or more fields, represented by another node of the plurality of nodes of the dependency graph, then some implementations may comprise generating a directional edge between the node representing the particular objective term and the node representing the particular field. The directional edge may indicate a direction from the node representing the particular objective term to the node representing the particular field.

If a particular constraint of the one or more constraints, represented by a node of the plurality of nodes of the dependency graph, uses a particular field of the one or more fields, represented by another node of the plurality of nodes of the dependency graph, then some implementations may comprise generating a directional edge between the node representing the particular constraint and the node representing the particular field. If a particular constraint of the one or more constraints, represented by a node of the plurality of nodes of the dependency graph, uses a particular variable of the one or more variables, represented by another node of the plurality of nodes of the dependency graph, then some implementations may comprise generating a directional edge between the node representing the particular constraint and the node representing the particular variable.

In some implementations, a system comprises one or more processors and memory storing instructions that, when executed by the one or more processors, cause the system to perform: receiving an optimization model, the optimization model including one or more objective terms, one or more variables, one or more constraints, and one or more fields, generating a dependency graph including a plurality of nodes based on the optimization model, the dependency graph including a node of the plurality of nodes for each of the one or more objective terms, the one or more variables, the one or more constraints, and the one or more fields, generating a first directional edge between a first node of the plurality of nodes representing a first variable of the one or more variable and a second node of the plurality of nodes representing a first objective term of the one or more objective terms, if the first variable participates in the first objective term, receiving a query requesting explanation information regarding the optimization model, traversing a path of the dependency graph starting from a root node until traversing an edge from a particular constraint node to a particular field node (e.g., particular data field node), the root node being based on an issue identified in the query, if the path from the root node to the particular field node include variables that are positive, then: reviewing the path from the particular field node to the root node to generate explanation information that explains decisions related to the issue identified in the query related to the optimization model, and providing the explanation information to a digital device (e.g., a device of a user or other entity).

Various embodiments of the present disclosure include systems (e.g., having one or more processors, and memory storing instructions that, when executed by the one or more processors, cause the system to perform functionality described herein), methods, and non-transitory computer-readable medium (or media) configured to perform obtaining an optimization model; generating a dependency graph based on the optimization model; receiving a query; traversing a path of the dependency graph; reviewing the traversed path of the dependency graph; generating explanation information, based on reviewing the path of the dependency graph, that explains decisions related to an issue identified in the query; and performing a corrective action based on the explanation information and the optimization model.

In some embodiments, the optimization model includes one or more objective terms, one or more variables, one or more constraints, and one or more data fields. In some embodiments, the dependency graph includes nodes, wherein the nodes include: a root node based on the issue identified in the query; and a node for each of the one or more objective terms, the one or more variables, the one or more constraints, and the one or more data fields; wherein traversing the dependency graph includes starting from the root node and traversing an edge from a particular objective term node to a particular data field node; and wherein reviewing the traversed path includes reviewing the traversed path from the particular data field node to the root node.

The systems, methods, and non-transitory computer-readable medium (or media) may be further configured to perform generating a first directional edge between a first node of the plurality of nodes representing a first variable of the one or more variable and a second node of the plurality of nodes representing a first objective term of the one or more objective terms, if the first variable participates the first objective term. In some embodiments, reviewing the path from the particular data field node to the root node occurs if the path from the root node to the particular data field node includes variables that are both positive and slack. The systems, methods, and non-transitory computer-readable medium (or media) may be further configured to perform receiving at least one solution to the optimization model, the dependency graph being generated based on the optimization model and the at least one solution.

The systems, methods, and non-transitory computer-readable medium (or media) may be further configured to perform further comprising providing an interactive visualization of an explainability graph, the explainability graph including the root node and all nodes along the path used to provide the explanation information. The systems, methods, and non-transitory computer-readable medium (or media) may be further configured to perform if a particular objective term of the one or more objective terms, represented by a node of the nodes of the dependency graph, uses a particular data field of the one or more data fields, represented by another node of the nodes of the dependency graph, then generating a directional edge between the node representing the particular objective term and the node representing the particular data field. In some embodiments, the directional edge indicates a direction from the node representing the particular objective term to the node representing the particular data field.

The systems, methods, and non-transitory computer-readable medium (or media) may be further configured to perform if a particular constraint of the one or more constraints, represented by a node of the nodes of the dependency graph, uses a particular data field of the one or more data fields, represented by another node of the nodes of the dependency graph, then generating a directional edge between the node representing the particular constraint and the node representing the particular data field. The systems, methods, and non-transitory computer-readable medium (or media) may be further configured to perform if a particular constraint of the one or more constraints, represented by a node of the nodes of the dependency graph, uses a particular variable of the one or more variables, represented by another node of the nodes of the dependency graph, then generating a directional edge between the node representing the particular constraint and the node representing the particular variable.

In some embodiments, the optimization model is associated with one or more optimization problems. In some embodiments, the optimization problem comprises a degradation optimization problem. In some embodiments, the degradation problem is associated with any of degradable or perishable components. In some embodiments, the perishable components include virtual assets (e.g., NFTs). In some embodiments, the perishable components are determined based on any of countdown timers and timestamps. In some embodiments, the optimization model includes any of convex optimization, optimization under uncertainty, or nonconvex optimization. In some embodiments, the convex optimization may be constrained or unconstrained, wherein a constrained optimization may be a nonlinear constrained optimization or a linearly-constrained optimization, wherein a nonlinear constrained optimization may be a semi definite programming problem, a quadratically constrained quadratic programming problem, a semi-infinite programming problem, or a second-order cone programming problem.

The linear constrained optimization may be a linear programming problem, a network optimization, a quadratic programming problem, a bound-constrained optimization, a smooth optimization, or a nonsmooth optimization, wherein the optimization under uncertainty may be a robust optimization or a stochastic programming problem, wherein the nonconvex optimization may be a continuous optimization (e.g., a nonlinear least squares), an unconstrained optimization, or a constrained optimization, wherein a constrained optimization may be a nonlinear optimization (e.g., a quadratic programming problem or a bound constrained optimization), or a mathematical programming problem with equilibrium constraints (e.g., complementarity problems), and wherein the nonconvex optimization may be a discrete optimization such as a combinatorial optimization, integer programming problem, mixed-integer nonlinear programming problem, or a network optimization.

In some embodiments, the optimization problem comprises any of a pharmaceutical manufacturer optimization problem, a food manufacturer optimization problem, a virtual asset optimization problem, electronics manufacturer optimization, agriculture harvesting optimization, metallurgy optimization, and vehicle and aircraft manufacturing optimization. In some embodiments, generating the explanation information includes using a multimodal model to generate natural language explanation information. In some embodiments, the multimodal model includes a large language model (LLM) and/or omni-modal model. In some embodiments, the query is received through an interactive chat interface, and the natural language explanation information is displayed through the interactive chat interface. In some embodiments, the corrective action includes adjusting physical equipment of a manufacturing process.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform providing a query regarding a solution to an optimization problem; receiving, based on the query, explanation information associated with an optimization model used to solve the optimization problem, wherein the explanation information explains decisions related to the solution of the optimization problem; and performing a corrective action based on the optimization model and the explanation information. In some embodiments, the corrective action includes an adjustment to one or more physical manufacturing processes.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform obtaining an optimization model; generating a dependency graph based on the optimization model; receiving a query; traversing a path of the dependency graph; generating an explanation tree based on reviewing a reversal of the traversed path of the dependency graph; providing the explanation tree to a multimodal model; generating, by the multimodal based on the explanation tree, explanation information that explains decisions related to an issue identified in the query; and performing a corrective action based on the explanation information and the optimization model. In some embodiments, the multimodal model includes a large language model (LLM) and/or omni-modal model.

These and other features of the systems, methods, and non-transitory computer readable media disclosed herein, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

1. A method comprising:
generating, by a processor, a dependency graph based on an optimization model;
traversing a path of the dependency graph based on a query;
reviewing, by the processor, the traversed path of the dependency graph;
generating, by the processor, explanation information, based on reviewing the path of the dependency graph, that explains decisions related to an issue identified in the query; and
executing instructions for a corrective action based on the explanation information and the optimization model.

2. The method of claim 1, wherein the optimization model includes one or more objective terms, one or more variables, one or more constraints, and one or more data fields.

3. The method of claim 2, wherein the dependency graph includes nodes, wherein the nodes include:
a root node based on the issue identified in the query; and
a node for each of the one or more objective terms, the one or more variables, the one or more constraints, and the one or more data fields;
wherein traversing the dependency graph includes starting from the root node and traversing an edge from a particular objective term node to a particular data field node; and
wherein reviewing the traversed path includes reviewing the traversed path from the particular data field node to the root node.

4. The method of claim 3, further comprising generating a first directional edge between a first node of the nodes representing a first variable of the one or more variable and a second node of the nodes representing a first objective term of the one or more objective terms, if the first variable participates the first objective term.

5. The method of claim 4, wherein reviewing the path from the particular data field node to the root node occurs if the path from the root node to the particular data field node includes variables that are both positive and slack.

6. The method of claim 1, further comprising receiving at least one solution to the optimization model, the dependency graph being generated based on the optimization model and the at least one solution.

7. The method of claim 5, further comprising providing an interactive visualization of an explainability graph, the explainability graph including the root node and all nodes along the path used to provide the explanation information.

8. The method of claim 5, further comprising:
if a particular objective term of the one or more objective terms, represented by a node of the nodes of the dependency graph, uses a particular data field of the one or more data fields, represented by another node of the nodes of the dependency graph, then generating a directional edge between the node representing the particular objective term and the node representing the particular data field.

9. The method of claim 8, wherein the directional edge indicates a direction from the node representing the particular objective term to the node representing the particular data field.

10. The method of claim 9, further comprising:
if a particular constraint of the one or more constraints, represented by a node of the nodes of the dependency graph, uses a particular data field of the one or more data fields, represented by another node of the nodes of the dependency graph, then generating a directional edge between the node representing the particular constraint and the node representing the particular data field.

11. The method of claim 10, further comprising:
if a particular constraint of the one or more constraints, represented by a node of the nodes of the dependency graph, uses a particular variable of the one or more variables, represented by another node of the nodes of the dependency graph, then generating a directional edge between the node representing the particular constraint and the node representing the particular variable.

12. The method of claim 1, wherein the optimization model is associated with one or more optimization problems that comprises a degradation optimization problem.

13. The method of claim 12, wherein the degradation problem is associated with any of degradable or perishable components determined based on any of countdown timers and timestamps.

14. The method of claim 13, wherein the perishable components include virtual assets (e.g., NFTs).

15. The method of claim 1, wherein the optimization model includes any of convex optimization, optimization under uncertainty, or nonconvex optimization.

16. The method of claim 15, wherein the convex optimization may be constrained or unconstrained, wherein a constrained optimization may be a nonlinear constrained optimization or a linearly-constrained optimization, wherein a nonlinear constrained optimization may be a semi definite programming problem, a quadratically constrained quadratic programming problem, a semi-infinite programming problem, or a second-order cone programming problem.

17. The method of claim 12, wherein the optimization problem comprises any of a pharmaceutical manufacturer optimization problem, a food manufacturer optimization problem, a virtual asset optimization problem, electronics manufacturer optimization, agriculture harvesting optimization, metallurgy optimization, and vehicle and aircraft manufacturing optimization.

18. The method of claim 1, wherein generating the explanation information includes using a multimodal model to generate natural language explanation information.

19. The method of claim 18, wherein the query is received through an interactive chat interface, and a natural language explanation information is displayed through the interactive chat interface.

20. The method of claim 1, wherein the corrective action includes transmitting one or more control signals for adjusting physical equipment of a manufacturing process.

21. A method comprising:
providing a query regarding a solution to an optimization problem;
receiving, based on the query, explanation information associated with an optimization model used to solve the optimization problem, wherein the explanation information explains decisions related to the solution of the optimization problem; and
executing instructions for a corrective action includes transmitting one or more control signals for based on the optimization model and the explanation information.

22. The method of claim 21, wherein the corrective action includes transmitting one or more control signals for an adjustment to one or more physical manufacturing processes.
